(19) United States
(12) Patent Application Publication
(10) Pub. No.: US 2011/0130906 A1
(43) Pub. Date: Jun. 2, 2011

(54) Location Based Vehicle Data Logging and Diagnostic System and Method

(75) Inventor: Frank S. Mayer, San Diego, CA (US)

(73) Assignee: ISE CORPORATION, Poway, CA (US)

(21) Appl. No.: 12/650,304

(22) Filed: Dec. 30, 2009

Related U.S. Application Data
(63) Continuation-in-part of application No. 12/628,776, filed on Dec. 1, 2009.

(51) Int. Cl. B60W 20/00; G06F 7/00

(52) U.S. Cl. 701/22; 701/35; 701/33; 903/903

(57) ABSTRACT

A data logging unit configured for installation in a hybrid vehicle communicates with a user device configured to receive data from the data logging unit and to display selected portions of the data to a user for identification of potential vehicle faults associated with vehicle events reported by the vehicle's driver. The data logging unit has a data logger which communicates with hybrid drive system and other vehicle components to receive hybrid drive system data, and with a vehicle position sensor which detects location to receive vehicle location data. A data log processing module correlates location data with the corresponding vehicle data, and creates a correlated log of drive system data and associated vehicle location information, to allow identification of vehicle data within an event window based on vehicle location at the time of a reported event. Accordingly, a user may make a geographical request and the system will report vehicle data corresponding to the geographical request.

### BACKGROUND

1. Field of the Invention

The claimed invention relates generally to electrical data processing of hybrid drive system communications communicated over a vehicle communication bus to solve a diagnostic problem with the vehicle. In particular, the claimed invention relates to systems and methods for recording hybrid drive data in a manner that facilitates subsequent review.

2. Related Art

Vehicle telematics is a term used to define communicatively connected vehicles interchanging electronic data. These systems are used for a number of purposes, including collecting road tolls, managing road usage (intelligent transportation systems), pricing auto insurance, tracking fleet vehicle locations (fleet telematics), cold store logistics, recovering stolen vehicles, providing automatic collision notification, location-based driver information services. For example, General Motors' OnStar is an in-vehicle safety and security system created to help protect drivers on the road. OnStar touts an innovative three-button system that offers: 24-hour access to trained advisors, a connection to emergency assistance, and access to OnStar Hands-Free Calling.

While there are many applications for vehicle telematics, fleet telematics are of particular interest here. Fleet operators commonly use vehicle telematics systems and vehicle tracking for fleet management functions such as routing, dispatch, and on-board information and security. In tracking the vehicle or its cargo, communication is enabled between the vehicle and central station that has applications such as vehicle tracking software, programmed to monitor such aspects of travel as location, speed, and driver behavior.

A Fleet Telematics System (FTS) allows the information exchange between a commercial vehicle fleet and their central station, (e.g., the dispatching office or a transit authority). A FTS consists of mobile Vehicle Systems (VS) and a stationary Fleet Communication System (FCS). The FCS is a stand alone application maintained by the vehicle manufacturer or an internet service running by the supplier of the system. The communication with the FCS is realized by trunked radio, cellular, or satellite communication. Positioning of vehicles is also realized by satellite positioning systems and/or dead reckoning using gyroscope and odometer. Fleet Operators benefit from commercial vehicle telematics as they provide a useful, cost-saving, and liability limiting, logistics management tool for commercial fleets that transport goods or people.

Also of particular interest are remote diagnostics. Vehicle telematics systems have also be used in a limited fashion to diagnose or report a problem of the vehicle. In particular, a vehicle's built-in system will identify a mechanical or electronic problem, and, in response, the telematics package can report the problem. The telematics monitored system is also capable of notifying any problems to the owner of the vehicle via e-mail.

With the emergence of more complex vehicular systems such as over-the-road heavy-duty hybrid vehicles, there is a need for a more comprehensive, yet efficient telemetry system. This is particularly true for common carriers, which have an increased need for real-time information. However, with vehicle fleets having many vehicles, real-time solutions involve costly consumption of wireless radio bandwidth. It is therefore an object of the presently claimed invention to provide a system and method for efficient remote diagnostic and monitoring fleet communications of many related vehicles (e.g., a vehicle fleet).

In addition, while heavy duty hybrid drive systems may provide greater fuel efficiency than conventional vehicles, they include multiple subsystems and components having a higher interdependence. As such, a hybrid electric drive system may be less tolerant of subsystem or component failures that their conventional counterparts. Also, given that hybrid drives are predominately electrical, as opposed to mechanical, transient faults and/or failures occurring during operation are often less detectable at the end of the vehicle's drive cycle.

Additionally, an increasing number of modern vehicles include a data logger for recording information related to the vehicle. The data logger will record vehicle communications communicated over a vehicle communication bus. In troubleshooting problems with hybrid drive system and/or the vehicle, the troubleshooter will often have to rely on a driver's recollection of what happened and/or when it happened. While machines have no problem associating an event with a precise time, humans typically do not. Currently, a troubleshooter may obtain very broad/vague descriptions of the problem and a general time frame of when the problem occurred from the driver. For example, the driver may report that the event or fault happened at around 9:00 am when the event actually happened precisely at 09:37:43 am. Likewise a driver may vaguely remember and later report that the event occurred in sometime in the morning when the event actually occurred later in the day. Sometimes this reporting method is acceptable, for example, when an easily verifiable, specific event—like the engine light coming on—occurs. Other times, the method may be unsatisfactory, for example, when the only indication to the troubleshooter is that the driver heard the engine make a strange noise during the route.

Intra-vehicle communications are typically bus communications. Currently, most vehicle bus communications are made over a controller area network (CAN). A controller area network is a vehicle bus standard designed to allow microcontrollers and devices to communicate with each other within a vehicle without a host computer. With a bit rate of 1 Mbit/s, approx. 10,000 CAN messages per second can be transmitted with an average data length of 4 bytes and up to approx. 7,200 CAN messages per second with 8 bytes data length (standard format). While this provides for rich vehicle communications, here, a troubleshooter may have to sift through an immense quantity of data to find when an event actually occurred.

The current troubleshooting techniques or methods are inadequate because they can be very time consuming, and also may not uncover the cause of a vehicle event if the driver remembers the time frame incorrectly. It would therefore be desirable to develop a system and method that makes trouble shooting techniques to determine vehicle related faults easier.

### SUMMARY

Generally people remember the location(s) of an event better than time(s) of an event. That is also true of a driver of a heavy duty hybrid electric vehicle such as a transit bus during the occurrence of an event related to the heavy duty hybrid electric vehicle drive system. An “event” may include precise events such as an overvoltage condition on string 3 of ultracapacitor pack 2, or imprecise events such as hearing an unfamiliar noise from the drive system during an otherwise uneventful portion of a drive cycle, which are difficult to locate in vehicle data logs. As such, the present invention relates to a system for recording hybrid drive data using the vehicle's location as a reference. In particular, the system and method allow a user, for example a troubleshooter, to search for vehicle data (e.g., associated with a drive system event) based on the location of occurrence of an event, in addition to the time the event happened. In order to implement the invention, the logged data or vehicle operation information in the system is correlated with location information or data (e.g. location data received from a Global Position System (GPS)).

Embodiments described herein provide a data logger system in which both global positioning system (GPS) data and vehicle data received via a vehicle's controller area network (CAN) bus are recorded together, along with time stamps, so that the location of the vehicle at any time along with the vehicle data recorded at that time can be readily determined, and a diagnostic system which uses the time stamped GPS and vehicle data log to identify and display the logged vehicle data corresponding to a vehicle event location reported by a driver, to assist in identifying potential vehicle faults.

According to one aspect, a vehicle data logging and diagnostic system is provided, which comprises at least one data logging system configured for installation in a vehicle and at least one user device configured to receive data from the data logging system and to display selected portions of the data to a troubleshooter or user to allow them to identify potential vehicle faults associated with vehicle events reported by the vehicle's driver. The user device may be installed in the vehicle or located remote from the vehicle for communication with the data logging system over one or more communication networks. In one embodiment, both the data logging system and user device are associated with a remote server or central station which communicates over one or more networks with one or more vehicles and with one or more user devices which monitor vehicle operation.

In one embodiment, the data logging system includes a communication module which communicates with engine and other vehicle components over a communication channel or bus to receive data from the vehicle components, a vehicle position sensor which detects vehicle location and provides a current vehicle location output, a timer module, and a data log processing module which receives vehicle data from the communication module, vehicle location data from the vehicle position sensor, and time information from the timer module, correlates vehicle location data with the corresponding vehicle data based on time, and creates a chronological log of vehicle data and associated vehicle location information, and a data storage module associated with the processing module which stores the chronological log of vehicle data and vehicle location data. In one embodiment, the user or troubleshooter device has a display unit which is configured to display a graphical user interface to the user, a communication module which communicates with the data logging system to receive a chronological vehicle data log, a selection module which selects a portion of the logged data for display based on vehicle event location information received from a user, and a vehicle event or user interface processing module which controls the user interface to display the selected portion of logged data.

In one embodiment, the user interface processing module receives a location input from a user, associates the location input with the same location in the chronological vehicle data log, reads a time stamp associated with the identified location in the log, creates an event window of a predetermined time interval about the time stamp, and selects a portion of the logged data falling within the predetermined time interval for display on the user interface. This enables a user or troubleshooter to easily identify vehicle data associated with a vehicle event reported by a driver, and to use the identified vehicle data to identify any potential vehicle fault or failure associated with the event.

According to another aspect, a method of associating a vehicle event with corresponding stored vehicle data in a data log is provided, which comprises receiving vehicle data from vehicle components over a vehicle communication channel or bus and associating the vehicle data with timer information received from a clock, receiving vehicle location information from a vehicle location sensor and associating each vehicle location with a time, correlating each received vehicle location with vehicle data received at the same time as the location data and recording the location data and vehicle data chronologically in a vehicle data log with periodic time stamps. The method further comprises identifying a time associated with a vehicle event by looking up a location of the vehicle event in the vehicle data log, determining the time associated with that location from the time stamp in the log, selecting an event window of predetermined duration about the determined time, looking up all vehicle data within the window, and displaying the vehicle data associated with the event window to a user on a graphical user interface.

Other features and advantages of the present invention will become more readily apparent to those of ordinary skill in the art after reviewing the following detailed description and accompanying drawings.

### BRIEF DESCRIPTION OF THE DRAWINGS

The details of the present invention, both as to its structure and operation, may be gleaned in part by study of the accompanying drawings, in which like reference numerals refer to like parts, and in which:

FIG. 1 is a simplified schematic of an embodiment of a heavy-duty hybrid-electric vehicle drive system;

FIG. 2 is a block diagram illustrating one embodiment of a vehicle monitoring and diagnostic system for monitoring operation and status of a plurality of active vehicles in a fleet or the like;

FIG. 3A is a more detailed block diagram illustrating communications between one remote diagnostic unit (RDU) and one user device via the RDS server of FIG. 2;

FIG. 3B is a more detailed block diagram of one embodiment of the vehicle communication bus of FIG. 3A;

FIG. 4A is a block diagram illustrating communication between an RDU and individual vehicle components via the vehicle communication channel in each vehicle of the system of FIG. 2;

FIG. 4B is a more detailed block diagram of one embodiment of the virtual turnstile unit of FIG. 4A;

FIG. 5 is a more detailed block diagram of one embodiment of the fleet monitoring and diagnostic system (RDS) server at the operator/controller end of the system of FIG. 2;

FIG. 6 is a more detailed block diagram of one embodiment of the RDS client device installed in hybrid drive remote diagnostic unit user devices of the system of FIG. 2;

FIG. 7A is a simplified example of a screen shot illustrating vehicle status information displayed on a user interface at a user device or monitoring station using the system of FIGS. 2 to 6;

FIG. 7B illustrates an alternative, user-selectable screen shot illustrating selected vehicle information displayed in a different configuration on the user interface;

FIG. 8 illustrates a method for remotely monitoring a plurality of electric vehicle drive systems in the field;

FIGS. 9A and 9B are flow diagrams illustrating one embodiment of a method of vehicle monitoring and diagnosis using the system of FIGS. 2 to 6;

FIG. 10 is a flow diagram illustrating one embodiment of a diagnostic method for monitoring for vehicle faults and failures;

FIG. 11 is a simplified schematic of an embodiment of a heavy-duty hybrid-electric vehicle with an embodiment of a system for reviewing vehicle data and identifying vehicle faults;

FIG. 12 is a simplified schematic of a location based data logging system for recording hybrid drive data and vehicle location data in a hybrid electric vehicle;

FIG. 13 is a flow chart of an exemplary method for recording hybrid drive data in a hybrid electric vehicle,

FIG. 14 is a simplified schematic of an embodiment of a hybrid-electric vehicle communication network, illustrating a the location based hybrid vehicle data logging system;

FIG. 15 illustrates a functional schematic diagram of a location based vehicle diagnostic system configured to interact with the location based data logging system of FIG. 12;

FIG. 16A is a flow chart of an exemplary method for recording and analyzing hybrid drive data;

FIG. 16B is a flow chart of an exemplary method for reporting hybrid drive data;

FIGS. 17A and 17B are a flow diagrams illustrating one embodiment of a method of logging vehicle data and vehicle location data, interfacing with a user, and reporting vehicle data based on a location request;

FIG. 18A is a simplified example of a screen shot illustrating a map displayed on a user interface with a vehicle's route or GPS data points superimposed on the map to allow a troubleshooter to select a location where a vehicle event reported by a driver occurred;

FIG. 18B is a simplified example of a screen shot illustrating a map displayed on a user interface with a vehicle's route or GPS data points including iconic representations of key status information superimposed on the map;

FIG. 19 is a block diagram illustrating an example computer system 750 that may be used in connection with various embodiments described herein.

### DETAILED DESCRIPTION

Certain embodiments as disclosed herein provide for a vehicle data logging and fault identification system and method in which a vehicle data logger receives both vehicle location data from a location sensor and vehicle data from various vehicle components, and creates a chronological log of vehicle data and location data with associated time stamps, which is then used to create a user interface displaying vehicle data which correlates with a selected location in the log or which correlates with an event window covering a selected time span about the time stamp associated with the selected location in the log.

After reading this description it will become apparent to one skilled in the art how to implement the invention in various alternative embodiments and alternative applications. However, although various embodiments of the present invention are described herein, it is understood that these embodiments are presented by way of example only, and not limitation. As such, this detailed description of various alternative embodiments should not be construed to limit the scope or breadth of the present invention as set forth in the appended claims.

In embodiments of the disclosure, the systems and methods described below are for recording hybrid drive system data, and diagnosing and remotely monitoring a plurality of electric drive systems in electric or hybrid electric drive vehicles (e.g., HEVs, EVs), especially in heavy-duty electric drive vehicles (e.g., heavy-duty HEVs, heavy-duty EVs) and heavy-duty electric drive vocational vehicles. While the claimed invention is directed toward EVs and HEVs (hereinafter “HEVs”), the present disclosure may be extended to other vehicles or groups of vehicles. As used herein, a heavy-duty electric drive vehicle is an electric drive vehicle having a gross weight of over 8,500 lbs. A heavy-duty HEV will typically have a gross weight of over 10,000 lbs. and may include vehicles such as a metropolitan transit bus, a refuse collection truck, a semi tractor trailer, a tractor or other farm vehicle, a tram, or the like. Vocational vehicles may include heavy-duty single and tandem drive axles be used in vocational applications such as construction, heavy hauling, farming, mining, logging, oil fields and refuse.

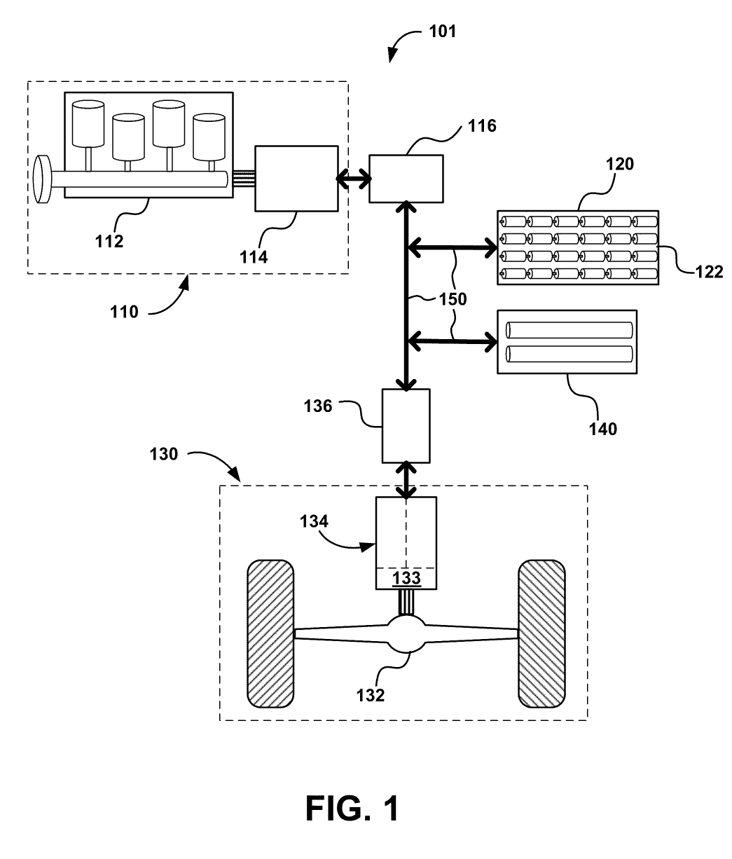

FIG. 1 illustrates a generic hybrid electric vehicle (HEV) drive system 101 in a “series” configuration, which may be used in a heavy-duty HEV. It is understood that HEVs may alternately have a “parallel” configuration (not shown). The components illustrated in FIG. 1 are some of the primary HEV propulsion system components. System 101 includes an energy generation source such as an “engine genset” 110 comprising an engine 112 coupled to a generator 114 and one or more electrical propulsion motors 134 mechanically coupled to a drive wheel assembly 132 via gearbox 133. As illustrated, the engine 112 of engine genset 110 may be a conventional gasoline or diesel internal combustion engine (ICE), or other types of vehicle drive engines such as a hydrogen fueled ICE (H-ICE), a compressed natural gas engine (CNG), a liquefied natural gas engine (LNG) or the like. In the alternate, engine genset 110 may be replaced by a fuel cell (not shown). The engine 112 (here illustrated as an ICE) drives generator 114, which generates electricity to power one or more electric propulsion motor(s) 134 and/or charge the energy storage cells of the energy storage via DC high power bus 150 (propulsion and charging power bus). In this way, energy can be transferred between components of the high power hybrid drive system as needed. As illustrated, HEV drive system 101 includes a first inverter 116 between the generator 114 and the DC high power bus 150, and a second inverter 136 between the electric propulsion motor 134 and the DC high power bus 150. Here the inverters 116, 136 are shown as separate devices, however it is understood that their functionality can be incorporated into a single unit. It is further understood that inverters 116 and 136 may function as rectifiers, or otherwise condition propulsion energy as appropriate.

Unique to a HEV, the vehicle will typically have both a high voltage electrical system and a low voltage electrical system. Hybrid drive system 101 provides the vehicle's high voltage system, which is partially illustrated in FIG. 1 by heavy lines, representing a high power supply for vehicle propulsion and other high power demands. Moreover, a HEV may include both AC and DC high power systems. For example, the drive system 101 may generate, and run on, high power AC, but it may also convert it to DC for storage and/or transfer between components across the DC high power bus 150. Current may be converted back and forth between AC and DC via the inverter/rectifier 116, 136 or other suitable device (hereinafter “inverters” or “AC-DC converters”). Inverters 116, 136 for heavy-duty vehicles (i.e., having a gross weight of over 10,000) are costly, specialized components, which may include, for example, a special high frequency (e.g., 2-10 kHz) IGBT multiple phase water-glycol cooled inverter with a rated DC voltage of 650 VDC and having a peak current of 300 A.

In addition to the high voltage power supply, the HEV also has a low voltage or auxiliary power supply which is used as the power supply of the starter that starts ICE engine 112, various low power vehicle devices such as a radio and lights, and various system controllers. The low voltage system is defined herein and being below 50VDC, but will typically comprise a 12VDC, 24VDC, or 48VDC power supply. The low voltage system is akin to the electrical system of a conventional (non-hybrid) vehicle.

Power from the propulsion energy storage 120 may solely power the one or more electric propulsion motor(s) 134 or may augment power provided by the engine genset 110. To appreciate the power level involved, heavy-duty HEVs may operate off a high voltage electrical power system rated at, for example, over 500 VDC. Similarly, propulsion motor(s) 134 for heavy-duty vehicles (here, having a gross weight of over 10,000) may include, for example, two AC induction motors that produce 85 kW of power (×2) and having a rated DC voltage of 650 VDC.

Unlike lower-rated electrical systems, heavy-duty high power HEV drive system components may also generate substantial amounts of heat. Due to the high temperatures generated, high power electronic components such as the generator 114 and electric propulsion motor(s) 134, for example, are typically cooled (e.g., water-glycol cooled), and may also be included in the same cooling loop as the ICE 112.

As a key added feature of HEV efficiency, many HEVs recapture the kinetic energy of the vehicle via regenerative braking rather than dissipating kinetic energy via friction braking. In particular, regenerative braking (“regen”) is where the electric propulsion motor(s) 134 are switched to operate as generators, and a reverse torque is applied to the drive wheel assembly 132. In this process, the vehicle is slowed down by the main drive motor(s) 134, which converts the vehicle's kinetic energy to electrical energy. As the vehicle transfers its kinetic energy to the motor(s) 134, now operating as a generator(s), the vehicle slows and electricity is generated and stored by the energy storage 120. When the vehicle needs this stored energy for acceleration or other power needs, it is released from energy storage 120. This is particularly valuable for vehicles whose drive cycles include a significant amount of stopping and accelerating (e.g., metropolitan transit buses). Regenerative braking may also be incorporated into an all-electric vehicle (EV) thereby providing an onboard source of electricity generation (recapture).

When the propulsion energy storage 120 reaches a predetermined capacity (e.g., fully charged), the drive wheel propulsion assembly 130 may continue to operate in regen for efficient braking. However, instead of storing the energy generated, any additional regenerated electricity may be dissipated through a resistive braking resistor 140. Typically, the braking resistor 140 is included in the cooling loop of the ICE 112, and dissipates the excess energy as heat.

Throughout a drive cycle, any of the above primary hybrid drive system components or subsystems may communicate over one or more communication networks. In addition, ancillary components and sub-systems not mentioned above may also communicate across the one or more networks, as well as components, accessories, and sub-systems associated with the vehicle. Given the importance of the proper interaction of all the hybrid drive system components and control of propulsion power, there are significant benefits to recording status information and the various communications for subsequent analysis and troubleshooting. Such communications and status information may be stored onboard the vehicle in a data logger or may be transmitted remotely to another location.

The sophistication of recording status information (datalogging) for a HEV drive system is very different than for a conventional vehicle. First, conventional vehicle drive systems are generally much simpler and require less communications. For example, the drive system is basically defined by a power source and multiple mechanical couplings ending at the wheels. Moreover, conventional vehicles only have a single low voltage common DC bus (thus there are no high voltage isolation issues). Second, conventional vehicles typically fail “slower”. In particular, being mechanically based, failures will typically have a longer lead up time before the actual failure, which will usually be accompanied by non-electronic indications. For example, failures in a mechanical system will typically be preceded by a period of perceivable indicators such as vibrations/oscillations, noises (e.g., squealing), overheating, etc. As such, conventional vehicles typically only record a few fault codes (e.g., OBD II codes) when a component or sensor detects a triggering condition. Diagnostics on conventional vehicles typically consists of reading one or more fault code and verifying whether or not the associate component is faulty.

In contrast, hybrid-electric vehicles are much more complex and heavily rely on drive system communications for operation. In a HEV, drive system components are in constant electronic communication with each other during normal operation, not just on the occurrence of a fault or failure. As such, there is a continuum of necessary, ongoing information transmittal available, which has no analog in a conventional vehicle. Moreover, electrical drive systems rarely break “slowly” or with a perceivable advance warning. Rather, drive system electrical failures are typically only preceded by a brief, nearly instantaneous electrical spike, or perhaps a short period of intense temperature. In addition, as discussed above, HEVs are characterized by an electrical, high voltage propulsion energy system and storage. The nature of, and hazards associated with, a HV system and its storage make it highly desirable to continually isolate it from the rest of the vehicle and monitor its performance. Also, HEVs drive systems are typically less familiar to a driver than conventional drive systems. For example a driver will easily recognize a fluid leak or a “rattling” in the transmission of a conventional vehicle, whereas he may not recognize or even understand a faulty IGBT in a second phase of the electric motor's inverter 136. As such, there is a heightened need for nearly continuous status information to prevent and/or diagnose HEV drive system failures, which has no analog in a conventional vehicle.

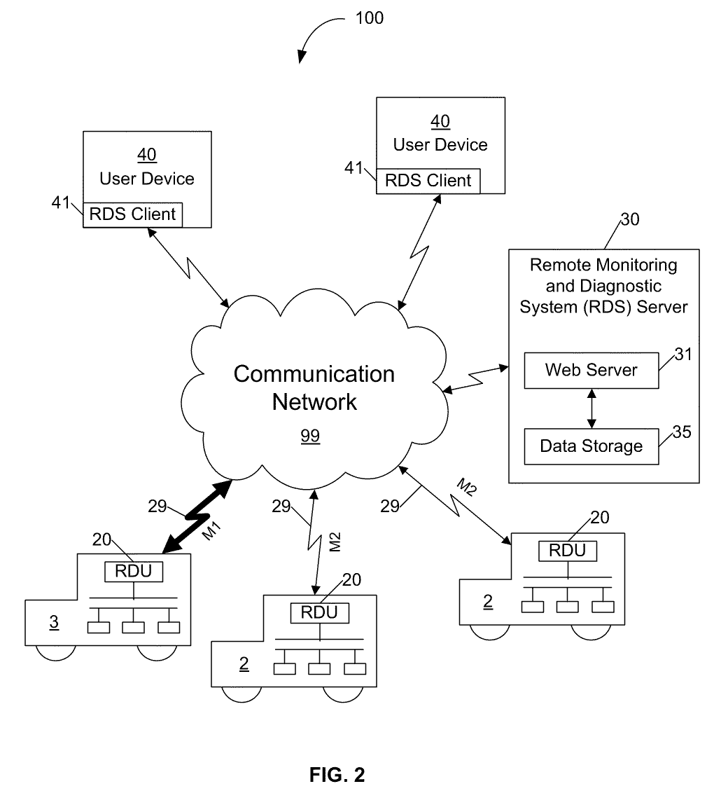

FIGS. 2 to 6 illustrate one embodiment of a system 100 for monitoring a plurality of hybrid electric drive systems installed in a fleet of vehicles 2, 3. Referring to FIG. 2, a fleet of three vehicles 2, 3 is illustrated for simplicity, however it is understood that a fleet may include many more vehicles (typically on the order of tens to hundreds). In addition, a fleet may be segregated by operator. For example, a particular hybrid drive system manufacturer may support a fleet of hundreds of vehicles, whereas individual operators/customers may only own fleets that consist of subsets of these vehicles (sub-fleets). As such, the present disclosure may be applied to an entire fleet and/or to sub-fleets. The fleet vehicles may be any type of vehicle including an electric and/or hybrid electric drive system communicably coupled to a vehicle communication bus. Preferably the fleet vehicles include heavy duty HEVs, and/or vocational vehicles, as described above. The EV's/HEV's may be powered by various power plants, e.g., internal combustion engines (ICEs)—such as conventional gas fueled engines, fuel cells, battery packs, etc. According to one alternate embodiment, the teachings of the present disclosure may also be applied to the drive systems of conventional vehicles and/or to merely the vehicle systems and components alone.

In the illustrated embodiment, the system 100 has a “vehicle side” comprising a plurality of vehicles 2, 3, and a user or “backend side” comprising a remote monitoring and diagnostic system (RDS) server or computer (“central monitoring station”) 30 and one or more user devices 40 having RDS client modules or RDS software 41, which communicates with the RDS server 30. The central monitoring station 30 and user device(s) 40 may be combined or separate. Fleet vehicles 2, 3 are all in wireless communication with the central monitoring station 30, however “selected” vehicle 3 is in a higher priority of communication than “non-selected” vehicles 2 (discussed below).

The system 100 further includes one or more communication networks 99, having one or more wireless links 29 for communications with vehicles 2, 3. The user devices 40 may be mobile or at remote locations, or may be a part of a computer system at a fleet management office. Each user device 40 is installed with software and/or hardware 41 for implementing the monitoring and diagnostic system and communicating with server 30 and vehicles 2, 3. RDS server 30 comprises one or more web servers 31 and associated data storage module or modules 35.

The one or more vehicles 2, 3, the server 30, and the one or more user devices 40 are all communicatively coupled via one or more networks 99. The network 99 includes a wireless network, which may include one or more wireless base stations (not illustrated). The network 99 is configured for communications over a wide geographical area and can be communicatively coupled with one or more public or private networks (not shown), which may include the aggregation of networks commonly known as the Internet.

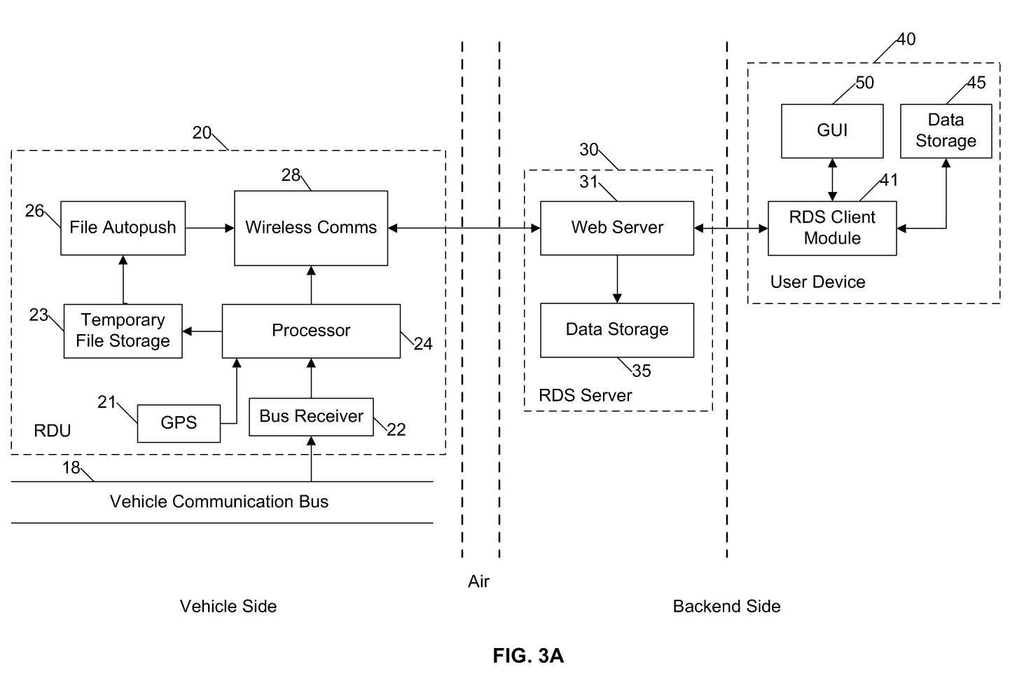

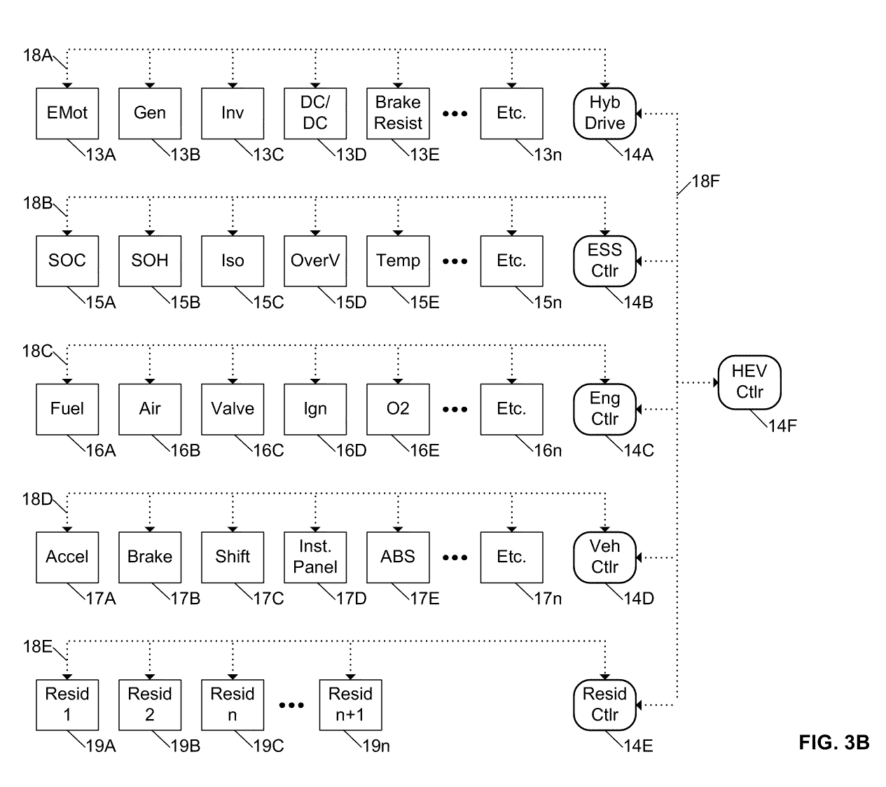

The vehicles 2, 3, the server 30, and the user devices 40 may be configured with data storage areas or storage devices 25, 35, 45, respectively (see also, FIG. 3A). The data storage areas 25, 35, 45 can be any sort of internal or external memory device and may include both persistent and volatile memories. The function of the data storage area 35 at RDS server 30 is to maintain data, such as data relating to the operations of the vehicles, for long-term and short-term storage and also to provide efficient and fast access to instructions for applications that are executed by server 30.

The one or more user devices 40 can be implemented using a conventional computer system or other communication devices with the ability to communicate over a network, and may be mobile or stationary units. The user devices 40 may include one or more of mobile stations, wireless communication devices, mobile units, personal digital assistants (“PDA”), personal computers (“PC”), laptop computers, wired or wireless telephones, wired or wireless email devices, PC cards, special purpose equipment, subscriber stations, wireless terminals, personal media players, handheld devices or the like. In some embodiments, one or more of the user devices 40 may be, for example, a wireless handheld device, a vehicle mounted device, a portable device, client premise equipment, a fixed location device, wireless plug-in accessory or the like or any combination of these and other devices capable of establishing a communication link over network 99 with the server 30 and vehicles 2, 3. In some implementations, RDS client modules or software 41 installed on the one or more user devices 40 may be configured to implement a user interface or graphical user interface (GUI) 50 on a user's browser (FIG. 3A) that is supported by the server 30. The user devices 40 may be operated by users such as engineers, fleet operators, maintenance personnel, and the like to determine real time operational vehicle status and other information which may be used for fleet operations monitoring, diagnostic purposes, report generation and the like, as described in more detail below. In addition the user devices 40 may be operated by users to access logged vehicle data.

FIG. 3A shows a more detailed block diagram illustrating communications between one remote diagnostic unit (RDU) 20 and one exemplary user device 40 via the RDS server of FIG. 2. As illustrated, the vehicle monitoring and diagnostic system has a “vehicle side” and a “backend side”. The vehicle side comprises a RDU 20 installed in the HEV, which communicates the vehicle's drive system (and other) information to the RDS server 30. The backend side comprises the RDS server 30 and the user device 40. The RDS server 30 transmits, records, and/or analyzes vehicle operation information and other vehicle information and statistics received from the vehicle side, and provides vehicle data to the user device 40. The user device 40 displays the vehicle information to a user and provides an interface for certain user commands to be sent to the HEV.

Referring to the vehicle-side's functional components, RDU 20 comprises a vehicle communication bus receiver 22 (e.g., CAN bus interface), a location determination module 21 (e.g., global positioning system (GPS)), a processor or control module 24, a temporary file storage 23 (e.g., flash memory), a file autopush module 26, and a remote diagnostic system (RDS) communication module 28, which may include a cellular transceiver and/or a point-to-point (PPP) communication protocol module. Module 28 may wirelessly communicate with RDS server 30 via cellular base stations (not illustrated) over one or more cellular and/or other communication networks. In one embodiment, RDU 20 may also include a failure/fault diagnostic module (not illustrated). Bus receiver 22 is communicably coupled to vehicle communication bus 18 and is configured to receive bus messages communicated between the various hybrid drive system components and subsystems of interest, as well as other communications of interest. Bus receiver 22 and processor 24 are illustrated separately, but may be integrated to form a single device or software application. Similarly, although the abovementioned functional units are illustrated separately, one or more may be combined together.

Here, bus 18 is illustrated as a single communication bus, however, it is understood that, especially with HEVs, bus 18 may represent multiple communication buses. In contrast to conventional vehicles, having for example a single bus (e.g., conforming to an OBD II standard), HEV's will often require multiple vehicle communication buses (e.g., controller area network (CAN) buses). For example, a HEV may retain the vehicle's traditional communication bus, but also require separate communication buses for the electric propulsion system, the propulsion energy storage, the power plant (e.g., engine), and a hybrid drive system integrating or master controller.

FIG. 3B, illustrates a more detailed block diagram of one embodiment of the vehicle communication bus of FIG. 3A. As discussed above, bus 18 may represent a communication bus network. In particular, bus 18 may include, for example, a dedicated hybrid propulsion/drive system communication bus 18A, a dedicated propulsion energy storage system communication bus 18B, a dedicated engine control communication bus 18C, a dedicated vehicle-only communication bus 18D, a dedicated non-vehicle (i.e., resident/hosted devices) communication bus 18E, and an integrating HEV communication bus 18F configured to integrate the HEV primary drive system, the energy storage, the engine, the vehicle components and subsystems, and the non-vehicle components and subsystems resident on the vehicle (e.g., passenger related services and/or monitoring). Each dedicated communication bus may then host a plurality of subsystems and components 13, 15, 16, 17, 19 (A to n) and controllers 14A, 14B, 14C, 14D, 14E as illustrated. Although one skilled in the art will immediately recognize the individual subsystems and controllers illustrated, it is understood that this illustrative listing is merely representative, and in no way limiting, as typical HEVs may have on the order of hundreds of communicating units. According to one embodiment, controllers 14A, 14B, 14C, 14D, 14E may function to process data, issue commands to various linked subsystems/components, and serve as a portal between the different communication buses 18A, 18B, 18C, 18D, 18E. In addition, according to alternate embodiments, the multiple communications buses 18A, 18B, 18C, 18D, 18E may be combined completely or partially with each other, having more or fewer controllers. Also, additional communication buses not shown may be included as part of the contemplated vehicle communication bus 18.

Returning to FIG. 3A and referring to the backend's functional components, RDS server 30 may include web server 31, data storage module 35, and one or more display units or user interfaces (not shown). Web server 31 may provide various functions, including management of both streamed vehicle data and vehicle data files to be stored. Files that are autopushed may be stored locally in RDS data storage 35 and/or forwarded to user device 40. User device 40 may include a RDS client module 41, GUI 50, and local user device data storage 45. In one embodiment, the RDS server or computer 30 and one or more user devices 40 may all be located at one facility, while in other embodiments, user devices 40 may be mobile user devices or user devices at different locations from RDS server 30.

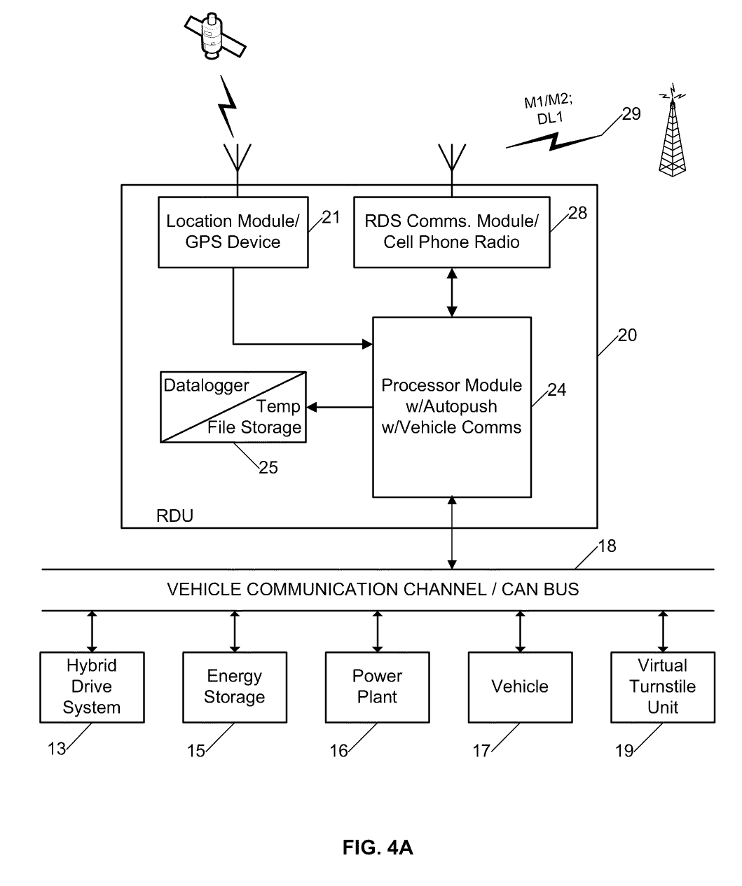

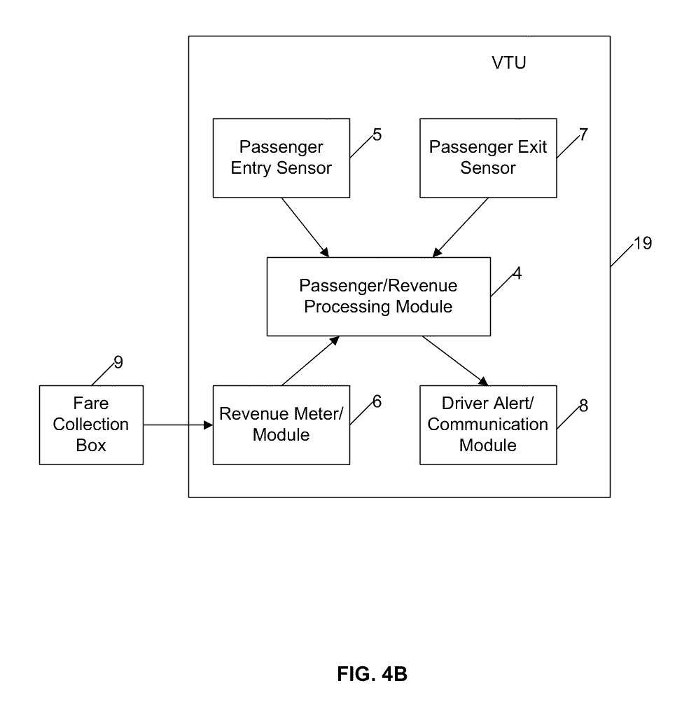

According to one embodiment, the RDU 20 may serve two primary functions. First, RDU 20 transmits hybrid drive system data communicated on the vehicle's communication bus 18, over the air, to the backend server 30, and ultimately to the user device 40. Generally, this vehicle data is streamed to the user device. It is understood that certain delays will be inherent in any communication scheme, but the transmissions intend to provide real time data reporting to a user. Second, the RDU 20 logs vehicle data. In particular, the RDU 20 sends data to be logged on RDS server 30 and/or user device 40. Generally, bus messages are packed as files, which are then transmitted to a remote storage 35, 45 when it is convenient to do so. According to an alternate embodiment, the RDU may log vehicle data locally in its own data storage (see e.g., FIG. 4A ref. 25). Similarly, according to this embodiment, the RDS server 30 and/or user device 40 (collectively, the backend) may serve two primary functions. First, the backend reports hybrid drive system data to a user, substantially in real time. Second, the backend logs data on RDS server 30 and/or user device 40.

With regard to the system's first primary function (i.e., real time data), given the volume of typical hybrid drive system communication bus messaging, the data received is preferably reduced prior to transmission. In particular, the data may be filtered by message source and/or sampled in advance of transmission. For example, according to one embodiment, the bus receiver 22 and/or processor 24 may receive all messages communicated over bus 18, determine a set of message sources of interest, and only pass on messages from a predetermined set of message sources. Only messages from those predetermined sources will then be transmitted.

According to one embodiment, the message sources may be further filtered according to the anticipated usage. In particular, the message sources may be limited to the subsystems and/or components of interest to a particular type user, for example an engineer may require different information that a transit operator. Message source/data filtering may be preprogrammed and/or selectably determined by a user. As will be discussed below, the message source/data filtering may also be dependent on whether the vehicle is “selected” or “non-selected”.

In addition to filtering the message sources, the processor 24 may sample or otherwise limit the number of messages passed on or streamed to the server 30. For example, rather than transmitting multiple instances of nearly identical data (e.g., a constant energy storage state of charge (SOC)), processor 24 may only use data when it varies by a threshold amount (e.g., the SOC as it varies by >5%). Also for example, rather than transmitting every message communicated over the bus 18 (e.g., a “generator output setting” reported every 20 ms), processor 24 may only transmit data at a reduced rate (e.g., the “generator output setting” every 1 sec). In addition, it is understood that sampling may be further varied according to bandwidth or other communication link limitations. In addition, it is understood that sampling may also be dependent on whether the vehicle is “selected” or “non-selected”, as will be discussed below.

With regard to the system's second primary function (i.e., logged data), as mentioned above, massive amounts of information are communicated across vehicle communication bus 18 during HEV operation. While a more limited “snap shot” of filtered, sampled, and/or otherwise limited vehicle data may be sufficient for the real time reporting purposes, it is desirable to have a more in-depth data record logged. However, excessive resources would be required to deliver all the data over-the-air to the backend in real time, thus, it may be impractical to do so. Advantageously, the RDU's logging function becomes less time-sensitive when combined with its sampled/filtered real time reporting function. Accordingly, in this embodiment, RDU 20 may convert vehicle communication bus communications into compact files, and buffer them in the temporary file storage 23. Later, the files may be automatically transmitted via file autopush module 26 at convenient times and/or during favorable transmission conditions (e.g., during lulls in real time transmissions). Also, being packaged as files, the messages are more amenable to being temporarily stored and then forwarded to a remote data storage 35, 45. Furthermore, as discrete files, the data may be transmitted in recoverable groups, the wireless communication device 28 may transmit the data file directly to the remote location without post processing, and the received data may be easier to interpret and manipulate by a user on the backend.

FIG. 4A is a block diagram illustrating communication paths between an RDU and individual HEV subsystems/components via the vehicle communication channel 18 in each fleet vehicle 2, 3 of the system 100 of FIG. 2. According to one preferred embodiment, the RDU 20 includes a location module 21 (e.g., GPS device), a central processor or control module 24, a data storage module 25, and a RDS communication module 28 (e.g., cell phone radio). Here, the RDU 20 is configured to communicate with and/or “listen to” various vehicle components 13, 15, 16, 17, 19 via a vehicle wired and/or wireless communication network 18. In the illustrated embodiment, communication is via a controller area network (CAN) communication channel or vehicle communication bus 18.

The various vehicle subsystems and components 13, 15, 16, 17, 19 may communicate with each other and provide status data to the RDU 20 via CAN bus 18. As discussed above, vehicle communication bus 18 may include multiple buses associated with the various vehicle subsystems and components 13, 15, 16, 17, 19. The vehicle components 13, 15, 16, 17 may include, for example, propulsion components (e.g., generator, electric motor, power inverter), energy storage and/or sensor components, engine operation sensors and/or components, vehicle air conditioning sensors or units, onboard computers, timers, and the like. Optionally, RDU 20 may communicate with both HEV components and non-vehicle components resident on the vehicle. For example, where the vehicles being monitored are passenger carrying vehicles such as transit buses, trolleys, trams, subways, and the like, one of the non-vehicle resident components which communicates with the RDU over CAN bus 18 may be a virtual turnstile unit (VTU) 19 that provides passenger and fare receipt data, and which is described in more detail below in connection with FIG. 4B.

A variety of information may be received via the vehicle communication bus 18. Here, CAN bus 18 is in compliance with a standardized vehicle bus standard designed to allow microcontrollers and devices to communicate with each other throughout the HEV, and without a host computer. As such, messages may be received, processed, and stored by RDU 20 without directly connecting with the message's source. Moreover, RDU 20 may simply pass on messages without understanding or evaluating its content. Accordingly, RDU 20 may be in direct communication with a message source, may passively receive messages sent between a message source and a message recipient, or any combination thereof. Hybrid drive system messages may include information associated with any of the HEVs components and subsystems, including the electric propulsion system, power control, and electrical accessories. Also included are communications associated with the propulsion energy storage, the engine, and other vehicle systems. For example, with regard to the energy storage 15, RDU 20 may receive status information such as voltage values, current values, charge value, charge rate, cell charge over time, time to reach maximum voltage, rate of change of voltage, capacitance, lower charge voltage, upper charge voltage, set time out for charging each energy storage cell of the plurality of energy storage cells, capacitance, lower charge voltage, upper charge voltage, set time out for charging each energy storage cell of the plurality of energy storage cells, applied charge, cell voltage, charge time, temperature values, and the like. In one embodiment, other types of vehicle data received, processed, and/or stored by the RDU 20 include speed, fuel usage/economy, mileage, location information received from a positioning system such as the Global Position System (GPS) at GPS module 21, timing information generated or received by a timing module such as a clock device of the vehicle, passenger and/or fare collection information generated by VTU 19, and the like. The number of vehicle status information items collected and stored by the RDU may comprise up to 200 items or more.

In addition to collecting raw data from the various vehicle sensors and operational components 13, 15, 16, 17, 19, the location module 21, and the like, the RDU 20 may also be configured to process the received data in central processor 24 and/or an optional failure/fault processing module (not shown) in order to produce other useful information such as total number of passengers, fuel economy or efficiency, and actual or potential component failures or faults. Passenger and fare data may alternatively be processed by the VTU and communicated to the RDU, as described in more detail below.

Continuing with FIG. 4A and referring to the RDU 20, according to one preferred embodiment, storage module 25 provides temporary file storage as in FIG. 3A, but also provides local, persistent file storage or datalogging, similar to the abovementioned backend data storage devices 35, 45. Files logged on storage module 25 may be later downloaded manually by service personnel, and/or written over when storage capacity has been met. According to one embodiment, memory 25 is partitioned such that stored data files are segregated from temporary files that are awaiting autopush transmission to the backend. Onboard data logging is beneficial because file downloading to the backend may then be omitted or reduced, or in the alternate, backend file downloading may still be continued for redundancy or other purposes, but may be advantageously delayed until times where the vehicle is not in operation (i.e., streaming has ceased) and/or scheduled when maximum bandwidth is available (e.g., evenings).

Also, according to one preferred embodiment, the central processor 24 may be configured to receive, process, and/or log real time vehicle operation data from many different vehicle components 13, 15, 16, 17, as well as real time location data and turnstile data from VTU 19, and buffer the received data separately in data storage unit 25 for subsequent transmission to the RDS server 30 in designated status messages at predetermined time intervals. In addition, central processor 24 may integrate both a CAN bus receiver and an autopush function. Also, processor 24 may perform certain control functions on the RDU 20.

In operation, central processor 24 may access messages communicated over the vehicle communication bus 18. In particular, processor 24 may receive, filter, and/or sample messages transmitted by one or more sources over the vehicle communication channel 18. In addition, processor may receive messages or data that is communicated directly to it (e.g., GPS or clock data). Generally, only a subset of the total messages will be logged, and an even smaller subset of the total messages will be reported real time to a user. As such, processor 24 may filter and/or sample received messages twice, one for messages to be logged, and another for messages to be streamed. Moreover, the subset of messages to be streamed may vary, as will be discussed below.

Also, in operation, processor 24 interacts with the received messages. In particular, processor 24 may re-construct or otherwise process the received messages and their data. For example, processor 24 may re-construct the received messages by combining multiple messages into a single file. Likewise, processor 24 may segregate messages and/or files according to their final usage. For example, messages and/or files may be segregated based on whether they are destined for a local datalogger, to be autopushed to remote storage, to be streamed to a user device 40, etc. According to one embodiment, processor 24 may process received messages by accessing the data contained within the messages for further analysis such as comparison to predetermined thresholds or prioritize transmission. Additionally, where processor 24 has a fault/failure determination module (not shown), a fault/failure flag may be appended to the data and or to a file. In this embodiment, messages or files having fault/failure flags may be prioritized in their transmission.

With regard to logged data, and where processor 24 includes an autopush function, processor 24 may synch files stored on the local storage module 25 with a remote storage 35, 45. Synching of locally logged data at storage module 25 with a remote backend storage 35, on the RDS server 30 for example, may be controlled by the autopush application in processing module 24. During the autopush sequence, processor 24 may then retrieve logged vehicle data files or messages (“DL1”) from local storage 25 (or partition thereof) and transmit them to the backend storage 35. The RDS server communication module 28 controls the process of sending of the vehicle data file DL1 over the cell phone link 29. The web server 31 at the RDS 30 controls recording the data file on the server data storage 35 and/or forwarding it to user devices 40. As discussed above, recorded data or messages DL1 may be advantageously delayed until convenient times.

With regard to real time data, processor 24 may vary the RDU 20 configuration, depending on what messaging is required, for example, whether it is on a “selected” vehicle 3 or “non-selected” vehicle 2. In particular, processor 24 may cause RDU 20 to transmit at a first setting that reflects a user directly monitoring the HEV (i.e. “selected” vehicle 3), and a second setting that reflects the HEV being online, but not selected. For example, according to one embodiment, the RDU central processor 24 is configured transmit one or more predetermined status messages or vehicle data to the backend or server side of the system at predetermined intervals, with each message containing selected vehicle data or status items. For example, the predetermined time interval for messages may be every 60 seconds, although different intervals may be used in alternative embodiments. During these intervals, in addition to any communications associated with keeping the wireless link up, the processor 24 may send additional real time vehicle data, especially adding key status information (i.e., partial HEV messaging) to the RDU transmission of the “non-selected” vehicle 2.

Continuing with FIG. 4A, in one preferred embodiment, the RDU 20 is configured to send first and second real time status messages (“M1” and “M2”) at predetermined first and second time intervals (“T1” and “T2”), depending on whether the vehicle is “selected” or “non-selected”. In particular, the first status message M1 is transmitted only for “selected” active vehicles 3 at time interval T1, while only the second status message M2 being transmitted at the longer time interval T2 for “non-selected vehicles” 2. To illustrate, the first time interval T1 may be “fast” (e.g., every 500 milliseconds), and the second time interval T2 may be “slow” (e.g., every 60 seconds). It is understood that different time intervals may be used in alternative embodiments.

Alternately, both selected and non-selected vehicles 3, 2 may transmit the same messages at different rates or different messages at the same rates. In particular, according to one embodiment, first status message M1 may be transmitted for the one or more “selected” vehicles 3 at time interval T1, however, rather than creating a subset M2 of the M1 messages, the “non-selected” active vehicles 2 may be configured to transmit full M1 messages, but only at time interval T2, for display on the user interface or GUI 50. According to another embodiment, first status message M1 may still be transmitted for the one or more “selected” vehicles 3 at time interval T1, and a “partial” information status message M2 may be sent, however, at the same time interval as the “full” vehicle information status message M1 (i.e. T2=T1). In this way the non-selected vehicles 2 will have a quicker refresh rate. This may be particularly useful where M2 includes location or fault information.

According to another alternate embodiment, for the “non-selected” vehicles, a current first status message M1 may still be buffered in data storage 25 on the RDU 20, though not transmitted, so that current full information is readily available if one of the “non-selected” HEVs is subsequently selected for full or increased information display. As discussed above, partial information status message M2 preferably includes only a selected subset of information items for the vehicle. Any desired subset of the collected information items may be included in this message. Also, message M2 will preferably include a fault/failure flag.

Regarding message content, the first and second real time status messages M1 and M2 may contain vehicle information items drawing from substantially all available vehicle information received over the CAN bus, including status information on all vehicle components, along with the GPS information identifying vehicle position. Preferably, first real time status messages M1 may comprise substantially all available vehicle information received or information from substantially all vehicle message sources. This first message may be sampled down to accommodate any limitations of the wireless interface.

The second real time status message M2 may then contain a second group of vehicle information items or partial vehicle information (“key status information”), which may be a significantly smaller subset of the first status message. Typical status information reported in a partial status message M2 containing only partial or selected vehicle data may include one or more of:

a. Hybrid drive system fault/failure flag,

b. Propulsion Energy Storage Overvoltage,

c. Propulsion Energy Storage State of Health (SOH) or State of Charge (SOC),

d. Electrical System Isolation Resistance,

e. Vehicle Location, Speed, or Fuel Economy or average miles per gallon (mpg),

f. Number of Passengers or Vehicle Revenue,

g. Vehicle sensor output,

h. Status of particular vehicle components of interest such as generators, inverters, energy storage modules, electric motors, fuel cell, engine, and the like.

According to one embodiment, the partial vehicle status message sent by each RDU 20 may be a “fixed” or preset message having a predetermined subset of CAN and/or GPS data. For example the second message M2 may only include four data or key status information items such as vehicle location, speed, energy storage SOH, and high voltage system isolation.

Alternately, the partial status or second status messages M2 may include a user selectable subset of data items from a larger “menu” of CAN and GPS data (e.g., select subset of four from menu of twenty items). This is particularly advantageous where different type of users will be accessing the information. Accordingly, any other group of vehicle status information items may be selected by users and/or system controllers for reporting in the partial status messages M2, and different groups of information may be sent in message M2 to different user devices. To illustrate, in this embodiment each non-selected vehicle 2 may transmit a of 20 available message sources/data items to the RDS server 30, which are listed on a user device menu (e.g., numbered #1-#20). Using the menu on the user device 40, a first user may select items #1, #2, #3, and #18 to be reported via the GUI 50, while a second user may select #1, #7, #8, and #12. In response, the RDS server 30 then filters and reports the requested items in modified messages M2* to each respective user which each contain only the information items requested by that user. Another way would be for RDS server 30 to initially identify the requested items of the first and second users to the RDUs 20 of each non-selected, active vehicle. Then each non-selected vehicle 2 may transmit a reduced set of data items. For example, using the selected items above (i.e., #1, #2, #3, and #18 for first user, and #1, #7, #8, and #12 for second user), the RDS server 30 may request the non-selected, active vehicles to transmit items #: 1, 2, 3, 7, 8, 12, 18 in messages M2, which are forwarded to client devices 40. The client devices in turn may filter the information items to report or display items #1, 2, 3, 18 in the first user's GUI and items #1, 7, 8, 12 in the second user's GUI.

As discussed above, according to one embodiment, the partial or second status message M2 transmitted by the RDUs of active, non-selected vehicles may preferably include a system failure/fault flag in one data slot, but any remaining data slots may be modified by the user. In different implementations, the fault conditions could be determined by an onboard vehicle controller, the RDU 20, the RDS server 30, or even the RDS client device 41 or PC GUI. The RDU 20 or another on-board vehicle controller could also implement algorithms that predict a fault/failure based on historic information. Independent of the device that determines faults, once an out of tolerance condition is detected, remedial action may begin. For example, in the event the flag indicates a failure/fault, the system may provide an additional alert to the user. One such additional alert may include directing a request to the user asking whether he would like to select the failed/faulty vehicle for full RDS reporting. According to another embodiment, the system may automatically switch to the failed/faulty vehicle as the selected vehicle.

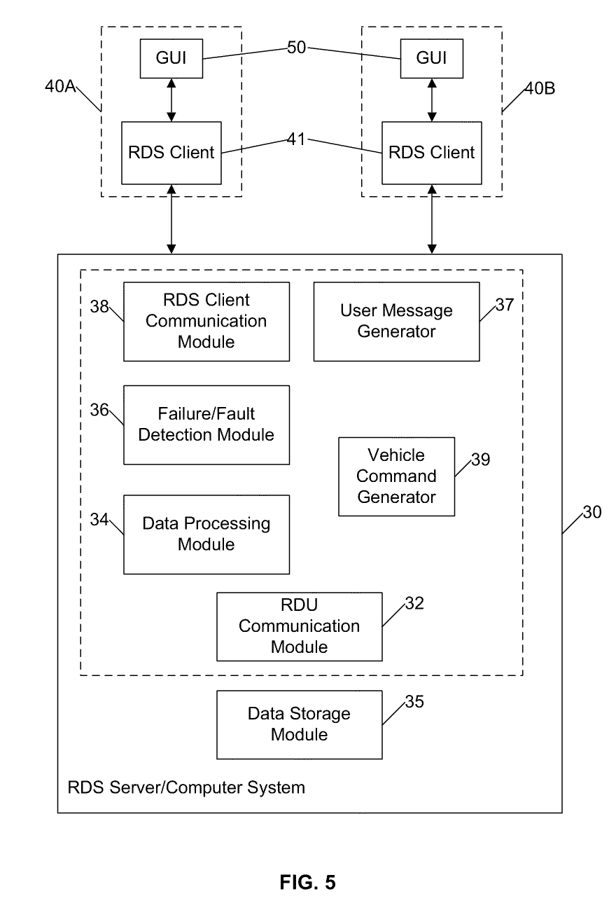

In addition to the ongoing reported messages, an initial status message, which may be a full or partial message (M1 or M2), is transmitted for all active vehicles upon start up. The initial message may be transmitted at the slow data rate, for example at time interval T2 (e.g., every 60 seconds). Alternately, this initial message may automatically, under certain specified conditions, be transmitted for one or more selected vehicles at a high data rate T1 (e.g., every 200 milliseconds). For example, when the vehicle is selected by a user at the backend, or when a fault or failure condition is recognized for that vehicle, the RDU 20 may automatically begin transmitting at the high rate T1. Thus, for such vehicles, the initial status message may be a first status message M1 that is transmitted at a high data rate T1. In either case, receipt of either message M1 or M2 indicates that the vehicle is currently online or otherwise operating. Thus, upon receiving either message, the RDS server 30 or RDS client device 41 may use it to generate a list of currently active vehicles in the user devices 40 currently registered to receive information for those vehicles, as described in more detail below in connection with FIGS. 5, 6, 7A and 7B.

Non-vehicle components and subsystems may reside on, be powered by, and even communicate with the vehicles 2, 3. In embodiments where the vehicles 2, 3 are passenger carrying vehicles, each vehicle may include an optional virtual turnstile unit or VTU 19 which communicates current passenger and/or fare information to the RDU, as illustrated in FIG. 4A.

FIG. 4B is a more detailed block diagram of one embodiment of the virtual turnstile unit of FIG. 4A. As illustrated, VTU 19 basically comprises a processing module 4, a first sensor 5 that detects passengers entering the vehicle, a second sensor 7 that detects passengers leaving the vehicle, a fare collection module or revenue meter 6, and a communication module 8 that communicates passenger and fare receipt information to the RDU 20 over the CAN bus. The communication module 8 may also be configured to send driver alerts to the vehicle driver under certain conditions, such as detection of a passenger who has not paid a fare.

In alternative embodiments, simpler versions of the VTU may be arranged just to count passengers or just to count revenue generated by the vehicle. The VTU may communicate detection of a passenger entering (and optionally also a passenger leaving the vehicle or bus) over the CAN network. The VTU processing module 4 may also add each counted passenger to a total number and communicate the total number over the CAN network for transmission by the RDU 20 to the backend or server side of the remote monitoring and diagnostic system 100. Additional analysis and reports may be generated and provided by the RDU processor 24, the VTU processor, or a combination of both, such as:

1. Number of passengers entering per period of time (e.g. every thirty minutes).

2. Number of passengers entering per location (e.g. bus stop).

3. Number of passengers entering per time of day (e.g. at lunch time).

In embodiments where the VTU includes sensors both for detecting passengers entering 5 the bus or other passenger vehicle and for detecting passengers leaving 7 the bus, either the RDU 20 or the VTU 19 may use this information to calculate other statistics, including the number of passengers leaving per location, per time period, and per time of day, as well as the total number of passengers on the bus at any one time. This is valuable for system operators to determine the most popular routes and possibly to add or reduce service, based on passenger and revenue levels. The VTU generated information may also be useful for additional reasons such as safety and information gathering in the event of an accident.

The revenue meter or fare collection module 6 may be connected to a bus fare collection box 9 adjacent the bus driver and may be used in conjunction with the passenger detection sensors or in isolation. The revenue meter 6 may communicatively couple the bus fare collection box 9 to the CAN network, and thus to the RDU 20, and report fares collected by the bus 2, 3. In one embodiment, the passenger sensors 5, 7 may be omitted and the VTU 19 may alternatively use the revenue meter 6 to count passengers entering the bus. In this embodiment, the VTU 19 sends a message that a passenger has entered the bus upon detection of a fare received in the fare collection box. The backend server 30 or the onboard VTU 19 or RDU 20 may use this information to calculate passenger statistics such as those listed above in connection with the passenger sensors, e.g. passengers entering per hour, per bus stop, or per time of day, and to generate passenger and revenue status reports for all vehicles and routes.

According to another embodiment, the VTU 19 may determine a passenger count through passenger sensors 5, 7, and determine revenue through the revenue meter 6. With this information, the VTU 19, RDU 20, and/or RDS 30 may determine and report various additional vehicle statistics. For example, the VTU 19 may also report the dollar amount received when a passenger enters the bus. Further, the VTU 19 may correlate the fare with a class of passenger (e.g., handicapped, student, regular, etc.), and report that information as well. This information can be used by the end-user to make decisions related to bus usage.

In addition, this information may be presented along with the vehicle conditions on a GUI 50 at one or more user devices to help transit authorities evaluate the efficiency of a route, or to help fleet managers understand whether a vehicle's performance, or lack thereof, is related to an external condition such as the passenger load being carried.

In another embodiment, the VTU processing module or computer 4 may determine when a passenger enters the bus but does not pay a fare, e.g. when the passenger sensor detects a passenger entry but no fare collection is detected by the revenue meter or fare collection box. This comparison may result in an additional reported parameter such as number of revenue generating passengers. This information may be used to reconcile with end-of-day revenue information reported by the driver. Additionally, certain information may be fed back to a user on the backend and the bus driver. For example, when it is determined that a passenger has not paid, this information may be fed back to the passenger, the driver, and/or a manager in the form of an alert via driver alert module 8. An alert such as an audible alert may deter passengers from attempting to enter the bus without paying the fare, or may give them cause to return to the driver to pay the fare. The driver may also be provided with a reset button acknowledging, and thus approving, the passenger. The reset button is connected to the VTU processing module 4 and the input from this button may be used to add another fare-paying passenger to the total passenger count.

Feedback may be provided to a backend office in the form of a priority message. This message may be sent via the RDU 20 or through an independent communication. The system may trigger a command to be issued on receipt of certain messages or under certain conditions. In particular, upon detecting a passenger has entered the bus without paying a fare, this may trigger an onboard camera to record an image of the passenger entering. The processing module 4 may then process the image to determine whether a passenger did in fact enter the vehicle, thus providing a more reliable turnstile. Alternately, the recorded image may be saved for other purposes such as driver safety and/or fraud detection purposes. Upon payment of a fare, the camera may then delete the saved picture.

According to an alternate embodiment, the RDU may include information on “paying passengers” and/or alerts of non-paying passengers when continuously reporting basic/partial information of a fleet. This and other information may be presented to a user in a graphical format, as described in more detail below. The system may also incorporate “static” information such as the name of the bus driver or route.

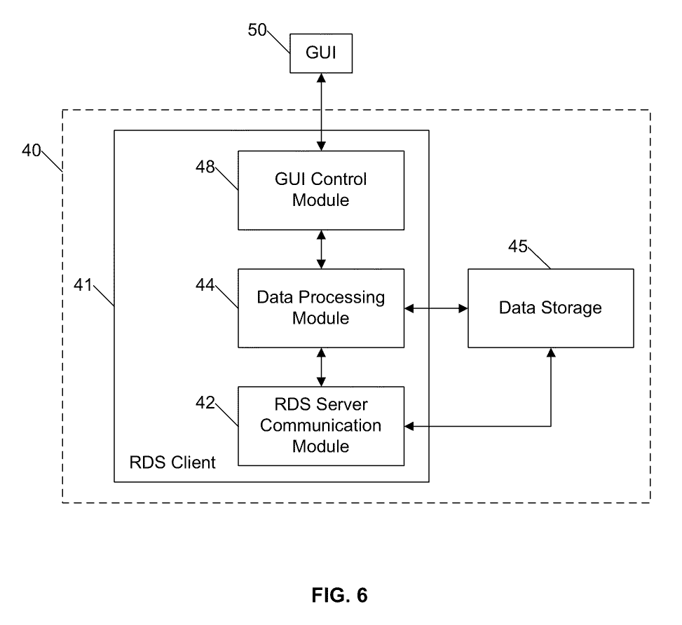

One embodiment of the backend or user/controller side of the system is illustrated in more detail in FIGS. 5 and 6. The system in one embodiment is a .NET based implementation comprising a web server application that provides graphical user interfaces 50 to remote user devices 40 (such as laptop computers, desktop computers, personal digital assistants (PDA), cell phones, or the like) over a network through a web browser on the user device, but other implementations may be used in alternative embodiments.

As illustrated in FIG. 5, the RDS server or computer system 30 basically comprises an RDU communication module or data receiving module 32 that receives first and second status messages M1, M2 from the RDUs 20 installed in fleet vehicles 2, 3, which are currently on-line, a data processing module 34 that processes the received data, a data storage module 35 that stores the received data along with program instructions, an RDS client communication module 38 that sends vehicle data to the user devices 40A, 40B authorized to receive the data, a vehicle command module 39 which sends commands to RDUs 20 via the RDU communication module 32, a user message generating module 37 that generates messages to users on the backend or server side of the system, and an optional failure/fault detection module 36 which analyzes incoming data to detect existing or potential vehicle faults or failures. Failure/fault detection module 36 may be, for example, a fault/failure detection system as described in co-pending application Ser. No. 11/273,387 (Patent Application Publication No. 2006/0149519) filed on Nov. 14, 2005. Alternatively, individual failure/fault detection modules may be installed in each vehicle in the fleet as part of the RDU 20 or as a stand alone module communicatively coupled to the other vehicle components over the CAN network.

The one or more displays or user devices 40A, 40B are configured with an RDS client 41 which may be software configured to display currently on-line vehicle information in a GUI 50 on, for example, a web browser, the vehicle information as generated by the backend server or computer 30 based on data received from the vehicles 2, 3, with the data being updated each time a new status message of any type for any of the listed vehicles is received. The partial and/or increased vehicle communication may be displayed on a web page supported by the remote server 30. The web page can be displayed on a remote user device 40A, 40B such as a computer system with a monitor, for example. In some embodiments, partial and/or increased vehicle communication may also be displayed in a GUI 50 on a computer screen associated with the server 30.

According to one preferred embodiment multiple user devices 40A, 40B may select different vehicles 3 via the central monitoring station 30. In particular, the selected vehicle 3 of user device 40A may be different from the selected vehicle 3 of user device 40B. Thus each vehicle be simultaneously a “selected” and “non-selected” vehicle 3, 2 and may communicate with the server so as to display different active vehicle information to multiple users in different locations. Here, both vehicles may transmit full messages M1 to the server 30, and the server 30 pass on the full message to one user device and only a subset of the full message to the other user device. Alternately, each RDU 20 may transmit both a full and partial message M1, M2 to the backend server 30.

In the case where there are multiple user devices 40A, 40B, it is preferable that access is managed by server 30. In particular, where not all users are authorized the same access, security measures may be included to limit/filter vehicle data that is not authorized to be used by a particular user. Access may be determined by comparing a user device's information against a library of authorized users and given the appropriate access.

FIG. 6 is a more detailed block diagram of one embodiment of the RDS client device installed in user devices of the system of FIG. 2. As illustrated, the RDS client 41 may comprise RDS server communication module 42, data processing module 44, and GUI control module 48 which controls the graphical user interface 50 displayed on a web page in the display screen of the user device. Similar to RDS client communication module 38, RDS server communication module 42 communicates with the server 30. Also, similar to the RDU's processor 24, data processing module 44 may route real time and logged data, may process the data, issue commands, and otherwise operate the user device 40.

In one embodiment, the user device 40 can also detect a fault or failure condition on the vehicle based on data contained in transmitted messages. The parameters needed to determine such a condition would stem from vehicle components that are nodes (or message sources) on the vehicle network(s) that the RDU 20 is connected to via CAN bus 18. The data processing module 44 may monitor and compare data against thresholds and take remedial action such as reporting and/or modifying RDU communications.

In one embodiment, where non-selected vehicles transmit a menu of selectable data, the RDS client 41 may be configured to control the GUI 50 to display only part of the information in each second status message M2 for a vehicle 2, 3, or all of the information, or may allow the user to select how much of the information in the second status message M2 is displayed. Similarly, where all vehicles only transmit first status messages M1 to all client devices 40, and the individual client devices 40 may be configured to control which information items are displayed. In particular, data processing module 44 may strip off all but the second message M2 information.

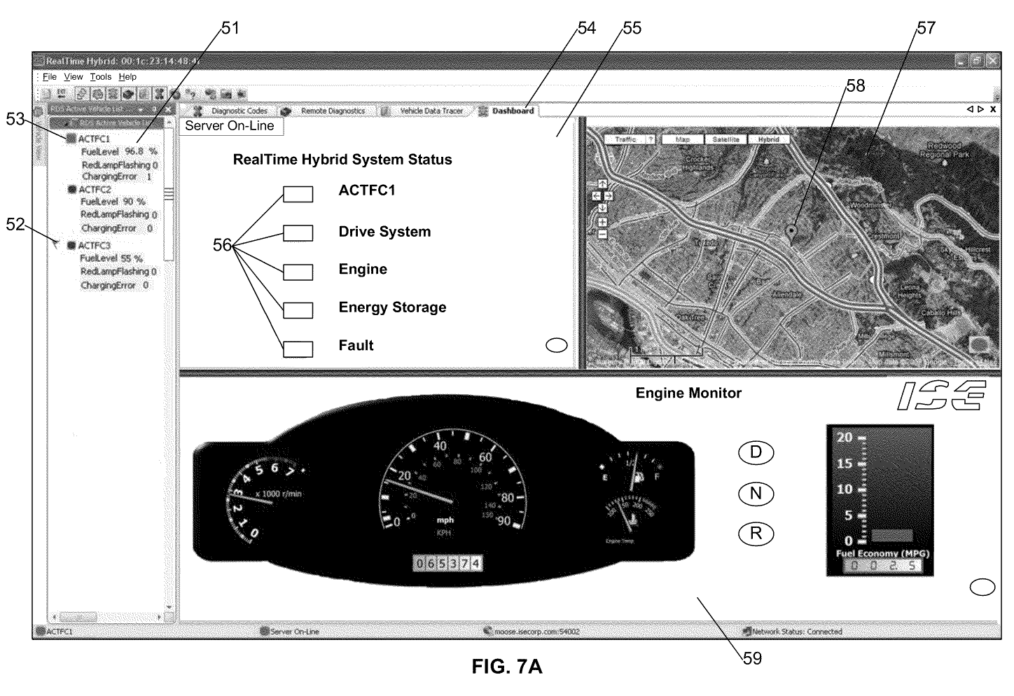

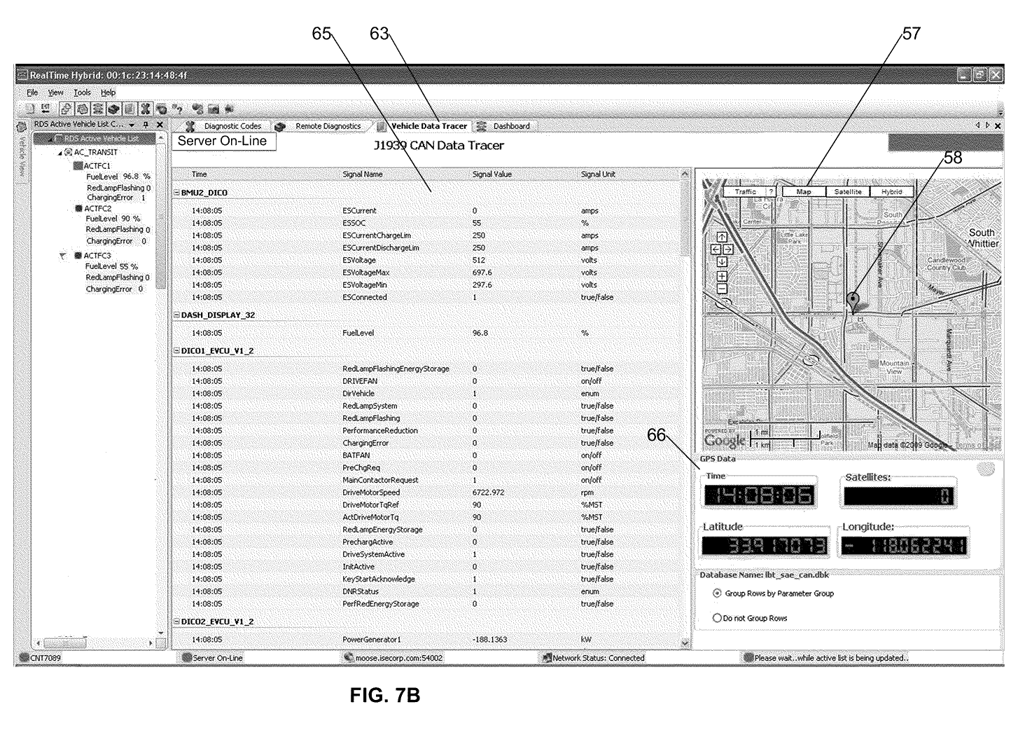

FIGS. 7A and 7B illustrate examples of a screen shot in a GUI 50 created by a client device or web server 40. The GUI 50 will generally include a list 51 in a side bar of all currently active vehicles in a fleet, along with associated partial status information for each vehicle. This list is continuously updated on receipt of new status messages. This list is also used to update the listed data, remove vehicles which are no longer active (i.e. status messages are no longer being received), and add any newly detected active vehicles (i.e. vehicles which have just started to send status messages). The user may select any desired vehicle in the list for display of more detailed information, and can choose different display modes or configurations, such as, for example, dashboard (FIG. 7A) or full vehicle data/text display (FIG. 7B).

In FIG. 7A, the information displayed in the side bar list 51 includes a vehicle name or identifier for each active vehicle which the user is authorized to monitor (in this case ACTFC1, ACTFC2, and ACTFC3, although a greater number of vehicles may be displayed in other examples). Selected vehicle 3 may or may not be included in list 51. As discussed earlier, partial message M2 may include any information desired by the user. Here, for example, the partial information M2 displayed in the list 51 for each vehicle comprises fuel level, red lamp flashing, and charging error, as well as a flag 52. This partial information M2 is displayed next to the vehicle identifier of any of the vehicles 2 which have a detected failure or fault, or a potential failure or fault, as determined by a fault detection module which may be located anywhere in the system, such as in the vehicle itself, in the RDS server system, or in the user device. In the illustrated example, a vehicle fault/failure flag is displayed for vehicle ACTFC3.

In the screen shot of FIG. 7A, the list 51 includes the selected vehicle 3 and the user has selected vehicle ACTFC1 for full information display, by clicking an icon 53 in the side bar alongside the vehicle name. A number of different display modes are available and may be selected by clicking one of the tabs along the top of the display screen. Here, the user has selected the tab 54 for Dashboard display. In this display, various vehicle systems are listed in system status area 55 along with tabs or boxes 56 alongside each system name which are in different colors based on the system status. For example, if the drive system, engine, and energy storage systems are all operating within normal range, the tabs 56 may be green. A fault condition is also listed under the vehicle system names, and the tab 56 alongside the fault indicator may be red if a fault or failure in any system has been detected. An area map 57 is displayed alongside the system status area 55, and includes an icon 58 indicating the current vehicle location. An engine monitor area 59 below areas 55 and 57 mimics the HEVs dashboard display of the fuel gauge, rpm, mph and other monitors on the vehicle dashboard, including current fuel economy.

In the screen shot of FIG. 7B, the user has selected a full data display by clicking on Vehicle Data tab 63. The full vehicle status display for the selected vehicle may provide the user with complete CAN information, which can be viewed in region 65, with the user scrolling down to see the complete list of CAN information. As in FIG. 7A, a map of the city or geographical area of fleet operation is displayed in region 57, with an icon 58 showing the current location of the selected vehicle using current GPS data. In one embodiment, the positions of non-selected, active vehicles may also be shown on the map in other icons (not illustrated) which may be a different color or otherwise distinguishable from the location icon 58 for the currently selected vehicle. Other GPS data may also be displayed in area 66 below the map 57. Other display modes may be provided, including a remote diagnostics display with more detailed information on the current condition of various vehicle components.

In one embodiment, the RDS server 30 or RDS client 41 may integrate the RDU reported information with non-vehicle data and/or third party data obtained off board the vehicle. Likewise, the additional status message data M2 of non-selected vehicles 2 may be simultaneously displayed or superimposed with the data of the selected vehicle. For example, in one embodiment, if “location” is included in the status message, the GUI map displaying the location of the selected vehicle may also display the location of non-selected vehicles where they are in the range of the map. Furthermore, the GUI 50 may display the following integrated information: a map of the city, all bus routes superimposed on the map, and an icon of each bus location along its respective route. The bus icon may also include some or all of the following data: the route number, the name of the driver, an image of the driver, the current number of passengers, and the like.

As discussed above, in one embodiment the RDUs of on-line or active vehicles transmit a partial data status message M2 containing selected CAN and GPS information items to the RDS, independent of the low rate, full CAN and GPS transmission of all vehicle data. Since the “presence data” (whether the vehicle is online) is only reported to the user interface at a longer time interval T2 such as every 60 seconds, the partial data status message need only be sent at time intervals T2 as well. The partial vehicle data may be displayed in the side bar or currently active vehicle list of FIGS. 7A and 7B, or may be displayed in an icon of the vehicle position on the map 57, or both.

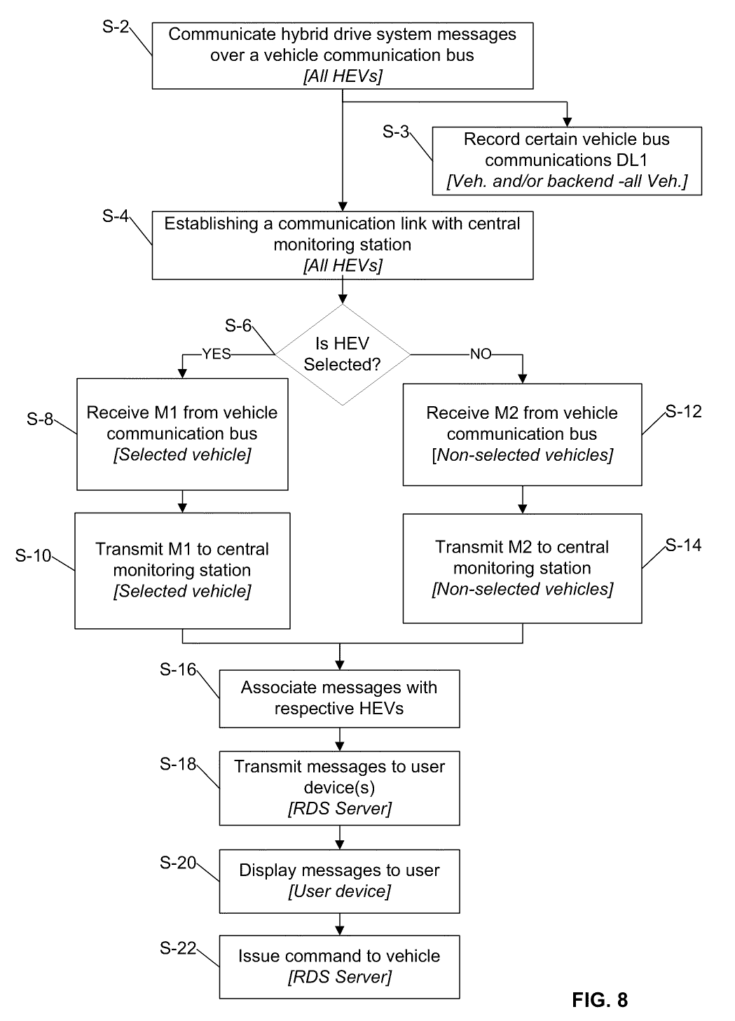

FIG. 8 illustrates a method for remotely monitoring a plurality of electric vehicle drive systems in the field. In general, the method is uses dissimilar real time transmissions between the plurality of vehicles and a central monitoring station such that all vehicles are transmitting vehicle communications, however, at least one selected vehicle is transmitting enhanced communications. In particular, all of the plurality of HEVs that are active or otherwise online will communicate hybrid drive system messages over a vehicle communication bus (S-2). Also, the HEVs will establish a communication link with the monitoring station (S-4). The wireless communication link may include a wireless communication link such as a cellular communications link. From the HEVs that have established communications with the central monitoring station, a user may direct the central monitoring station to select an HEV of interest as a “selected” vehicle (S-6). The at least one selected vehicle will receive a first subset (“M1”) of the real time hybrid drive system messages that are communicated over the vehicle communication bus (S-8). Preferably, this will include a sampling of the communicated messages from substantially all messages sources. As above, it is understood that the vehicle communication bus may include a communication network having multiple communication buses. In addition, while it is the intent to receive hybrid drive system messages, it is understood that other messages sources may also be included in bus communications (e.g., various vehicle components, drive system accessories, and resident systems). The at least one selected vehicle will then transmit the first subset of the hybrid drive system messages M1 to the central monitoring station for further processing (S-10). M1 transmissions may take place frequently at time intervals (“T1”).

Meanwhile, the “non-selected” vehicles will receive a second subset (“M2”) of the real time hybrid drive system messages that are communicated over the vehicle communication bus (S-12). As with the selected vehicle(s), this will include a sampling of communicated messages. However, in contrast, the second subset M2 will be substantially smaller than M1, and may only be associated with a predetermined subset of message sources, representing key status information. Key status information may be predetermined by the system and/or dynamically defined by the user and/or the system. The non-selected vehicles will then transmit the second subset of the hybrid drive system messages M1 to the central monitoring station for further processing (S-14). M2 transmissions may take place periodically at time intervals (“T2”), which may be less frequent that time intervals T1.

In both the selected and non-selected vehicles, the system will preferably record certain vehicle bus communications (S-15). The recorded messages (“DL1”) may include substantially all communicated messages, and may be recorded on the vehicle, on the backend, or both. Moreover, the recorded messages with be determined independent of whether the vehicle is selected or not. Recorded communications DL1 may be the same messages as transmitted real time as the first subset of messages M1, or may be the full, unsampled, M1 message group. Recorded messages DL1 may be combined into compact data files. Recorded messages DL1 may be recorded on the vehicle, on the backend, or both. However, where recorded messages DL1 are recorded on the backend, they will preferably be transmitted separately from the real time messages M1 and M2 and may be scheduled via an autopush algorithm.

At the backend, all messages transmitted will be associated with their respective source vehicle and further processed (S-16). Backend processing may include data logging (as in S-15), data analysis (e.g., failure/fault detection), forwarding to a user device (S-18), responding with control signals and or supplemental data. Where the messages are forwarded to a user device, both M1 and M2 messages may be displayed to the user simultaneously (S-20). Upon a request by a user and/or a determination by the system, a command may be issued to one or more vehicles (S-22). Preferably, the command will include selecting a new vehicle of interest and de-selecting a prior vehicle of interest responsive to vehicle data or key status information transmitted in M2 of the previously non-selected vehicle.

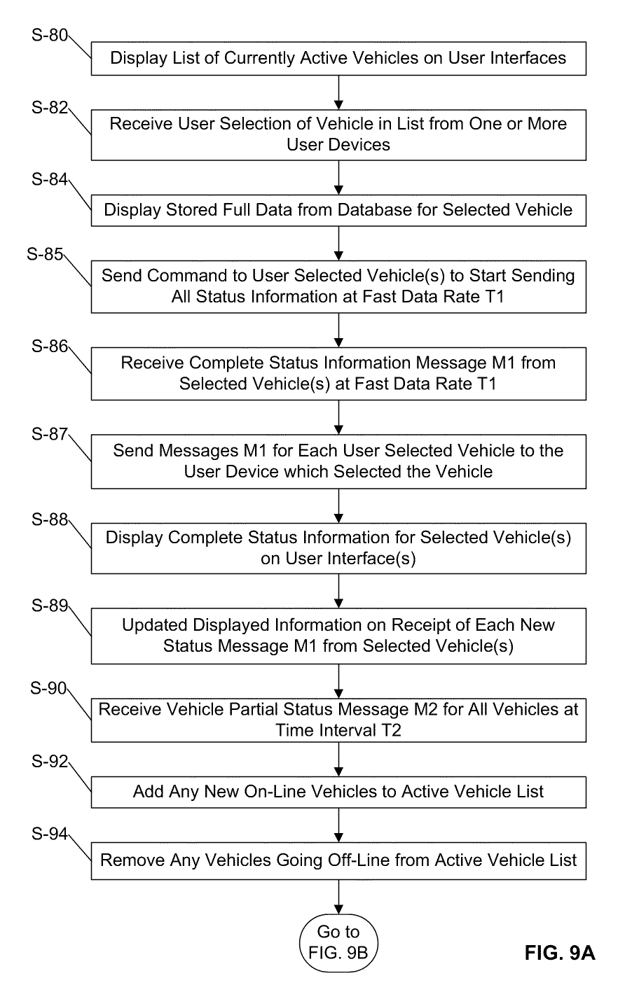

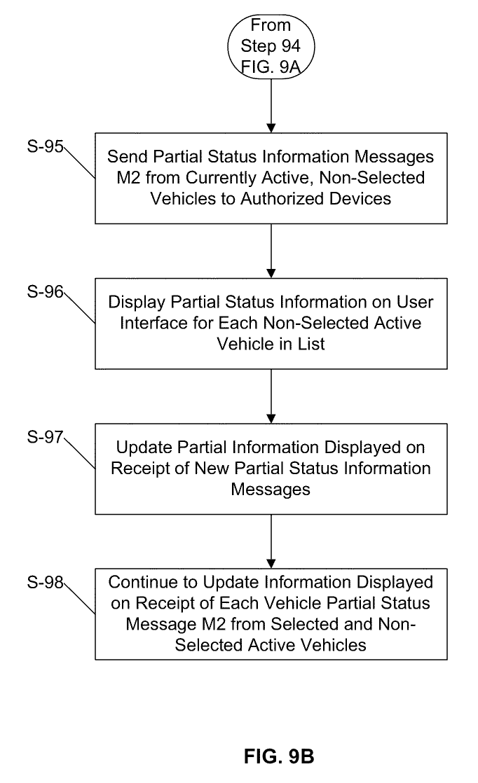

FIGS. 9A and 9B are flow diagrams illustrating one particular embodiment of a method of providing status and diagnostic information on active fleet vehicles to a user at a remote user device. As illustrated in FIG. 9A, the system is configured to display a list of identifiers or names of currently active or on-line vehicles 3 in the GUI (S-80). In one example, the list of currently active vehicles is displayed in a side bar, as illustrated in FIGS. 7A and 7B. This information is determined from the first or second real time messages (M1, M2), which are sent from each active vehicle's RDU to the RDS server at a time intervals T1 or T2, respectively. T1 may be a fast data rate such as transmissions every 200 milliseconds, whereas T2 may be a slow data rate such as transmissions every 60 seconds. The data processor module 34 at server 30 or the RDS client 41 at the respective user device may then interpret receipt of messages M1 or M2 from a previously unlisted vehicle as an indication that the vehicle is currently active, so that the vehicle is added to the active vehicle list along with the associated data. When no further messages M1 or M2 are received from a listed vehicle after expiry of the predetermined time period, the RDS processor module 34 or the RDS client 41 may determine that the vehicle is no longer active and removes it from the list.

When a user selects a vehicle from the current active list for full data display (S-82), the most recent stored full data for that vehicle (obtained from the previously received complete CAN and GPS data messages DL1 sent by each active vehicle at during an autopush) may be retrieved from the data base either at the RDS server 35 or the user device 45 and displayed in the GUI (S-84) in a user selected mode or configuration, for example as illustrated in FIGS. 7A and 7B. The user can select the display option from the tabs at the top of the screen, as described above. At the same time, a command may be sent to the user selected vehicle (S-85) to begin sending full data at a fast data rate T1, which may be every 0.5 seconds in one example. The RDS server then begins receiving full data messages M1 from the newly selected vehicle or vehicles at data rate T1 (S-86).

According to one embodiment, different user devices may select different vehicles as their respective “selected vehicle” for full display. This is particularly useful where multiple users are accessing a fleet and have different vehicles of interest. This is also useful when the central monitoring station 30 serves multiple users that are not authorized to monitor each other's fleets. Accordingly, the RDS server 30 filters incoming full data messages M1 from each user-selected vehicle and directs them to the appropriate user devices (S-87). In the latter case, where not all users are authorized the same access, security measures may be included to limit/filter vehicle data that is not authorized to be used by a particular user. Security measures may include user authentication (e.g., username and password) for example.

The GUI interface controller 48 at the respective user devices 40 then controls the GUIs to display selected or all vehicle information from messages M1 for the selected vehicle on the GUI (S-88), updating the display on receipt of each full data message (S-89). The full vehicle information continues to be updated on receipt of each full data message M1 while the vehicle is still selected and active. Vehicle information from active and selected vehicles may also be stored in the data storage module 45 in place of or in combination with any recorded messages or files DL1.

The RDS server 30 also receives updated partial or second messages M2 (key status information) for all currently active vehicles at a slower rate T2 (S-90). Each time a status message M2 is received, the currently active vehicle list is updated to add any newly active vehicles which have just started sending status messages M2 (S-92), or to remove any vehicles which have stopped sending status messages M2 (S-94), i.e. vehicles which have completed a trip or finished a duty cycle, are currently shut down, and/or are no longer transmitting. The list update of steps 92 and 94 may be carried out at the respective client devices 41 or at the RDS server 30. In the latter case, the RDS server 30 filters the data to provide a currently active vehicle list 51 to each user device which includes only the vehicles which the respective user device is authorized to monitor. This controls updating of the list of currently active vehicles displayed at step 80.

Continuing on to FIG. 9B, the RDS server 30 sends partial status information messages M2 received at a slow data rate T2 from all currently active or online vehicles to the user devices 40 authorized to receive information on the respective vehicles (S-95). Thus, the data processor 34 at the RDS server filters the messages M2 for each user device based on the vehicles which the respective user device 40 is authorized to monitor, which may be some or all vehicles in one or more fleets. The partial information or selected information items in messages M2 received at each user device 40 is displayed on the GUI 50 for that user device (S-96). The information items may be displayed in the active vehicle list adjacent the identification of the respective currently active vehicles, for example as illustrated in FIGS. 7A and 7B, and may additionally or alternatively be displayed in icons on a map indicating the current location of each currently active vehicle (not shown). The partial information items for each active vehicle are updated each time a new partial status message M2 for the respective vehicles is received (S-97). The RDS system 30 then continues to update the GUI 50 for each new vehicle partial status message M2 received from currently active vehicles and each new complete status message M1 received for the currently selected vehicle at the user device 40, and to update the data storage 45 (if used) with new information for each vehicle (S-98).

In addition to controlling the display of vehicle status information on the user device 40 of each participating user, such as fleet operators, maintenance personnel, and the like, the RDS server 30 may also perform other tasks, such as processing or analyzing incoming information for any vehicle failures or faults, processing the data to provide other useful information for display on the GUI 50 or in reports, such as route profitability and passenger capacities, and providing commands or alert messages to both users and vehicle drivers.

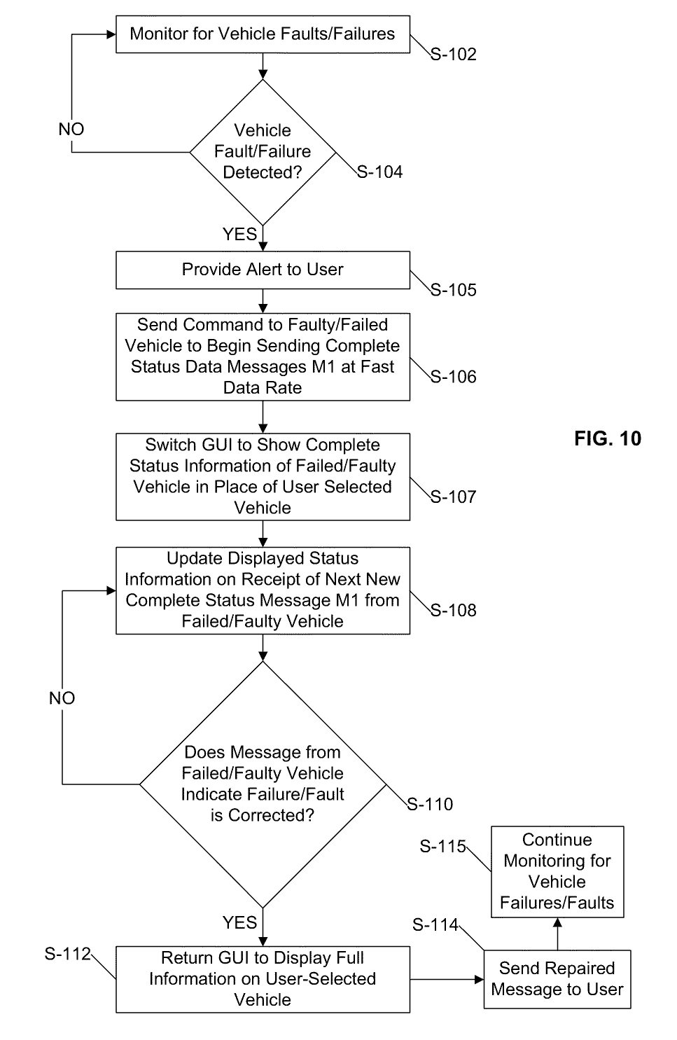

FIG. 10 illustrates a flow diagram of one embodiment of a method for monitoring for vehicle faults and failures. Both selected and non-selected vehicles may be monitored. Additionally, any selected part of the system, such as the RDU 20, the RDS server 30, or the client device 40 may be configured to continuously monitor for vehicle failures or faults (S-102). One way of doing this, as noted above, is to look for the failure/fault flag in incoming messages from RDUs 40, either at the RDS server 30 or at the individual client devices 40. In the event that the flag indicates a failure or fault (S-104), an additional alert may be sent to the user (S-105). Any current failure/fault flags are displayed 52 in the additional information in the active vehicle list 51, but the additional alert may prompt the user to take additional action such as starting a vehicle diagnostic procedure or contacting maintenance personnel. A command may also be sent to the failed/faulty vehicle to begin sending complete status information messages M1, or to start sending such messages at a faster data rate T1 (S-106). The graphical user interface GUI 50 may also optionally be switched automatically to the failed/faulty vehicle as the selected vehicle (S-107), so that the user or maintenance personnel see all data items associated with the components of that vehicle, for diagnostic purposes. Alternatively, a request may be sent to the user first, asking if they would like to select the failed/faulty vehicle for full reporting. The GUI status information for the failed/faulty vehicle is updated each time a new status message M1 is received from the vehicle (S-108). If a message indicates that the failed/faulty condition has been corrected (S-110), the GUI may be switched back to displaying information on the user-selected vehicle (S-112). A message or alert may be sent to the user to indicate that the fault/failure has been corrected (S-114), and the system continues to monitor for future failures or faults (S-115), repeating the procedure in FIG. 10 if a subsequent failure or fault is detected for any vehicle.

As discussed above, each RDU 20 or a separate vehicle controller may also be configured to detect any failures/faults or failure/fault messages, and the RDU 20 may be configured to automatically exit its default settings in the event of a detected failure or fault, and reconfigure itself to take one or more of the following actions:

1. Increase the transmit rate of the partial data status messages M2;

2. Transmit all available data, i.e. complete data messages M1, instead of partial data messages M2;

3. Send an independent Alert to the user with the status messages;

4. Send an independent Alert to one or more independent entities such as maintenance personnel over the RDU wireless link 29, e.g. to cell phones, emails or the like;

5. Increase the transmit rate for transmitted status messages;

6. Increase the sampling rate of the failed/faulty component or unit in the vehicle reporting the failure/fault condition;

7. Actively request specific predefined information from the failed unit over the CAN.

Alternatively, the RDS Server 30 or a user may detect a predefined failure/fault message, and command the RDU 20 to exit its default settings and perform any of the above actions. In addition, the RDS Server 30 may send a message to the user asking if he wants to expand the status message from the failed/faulty vehicle to include additional items from a list of all available items of interest. For example, if the status data indicates a coolant over-temperature condition, the backend system may offer to include coolant level, engine speed, and any other items that may be causing the over-temperature in the status message. Alternatively, the system may automatically reconfigure the RDU status message to include the information of interest.

In one embodiment, either the RDS server 30 or the vehicle RDUs 20, or both, are equipped with a diagnostic toolkit or failure/fault detection module, such as module 36 of FIG. 5. In addition to algorithms for predicting future failures or faults, this kit may include software for diagnosis and/or repair/reconfiguration of each individual component in the vehicle. Once a potential fault or failure is detected based on status information received over the vehicle CAN bus, the RDS points to the component and symptoms driving the error, and the diagnostic module may be used to further evaluate the condition and aid in repair.

With the arrangement described above, the remote diagnostic system is more accurate during fault conditions and provides for a quicker response time by users and maintenance personnel. This especially beneficial for hybrid electric vehicles having highly integrated electric drive system that may be more susceptible to transient faults than conventional vehicles and that and may include high voltage onboard energy and power control systems. Additionally, the RDU in combination with a VTU in the above embodiment provides revenue and route efficiency information useful for transit authorities and other fleet managers. The combined display of both hybrid drive system data, vehicle operational information, and passenger information allows easy access by users to all data of interest and allows them to easily monitor fleet performance and to identify faults and failures or potential faults and failures early, reducing maintenance response time. For example, where fuel economy data indicates that a particular vehicle is not performing at its expected economy level, the system may be reconfigured to send new performance parameters to adjust the engine or even configure the vehicle control software. In one embodiment, this may be done the next time the vehicle or bus is inoperative or shut down, i.e. outside normal operating hours.

This system also allows the remote diagnostic system to be tailored to suit the end-user's application, by allowing end users to select which information items are sent in periodic partial status messages M2 from RDUs or which information items from messages M2 are displayed in the GUI, and also allowing different users to receive different sets of information. For example, maintenance personnel may need operating information on various vehicle components, while fleet managers may want passenger and revenue information for route review purposes.

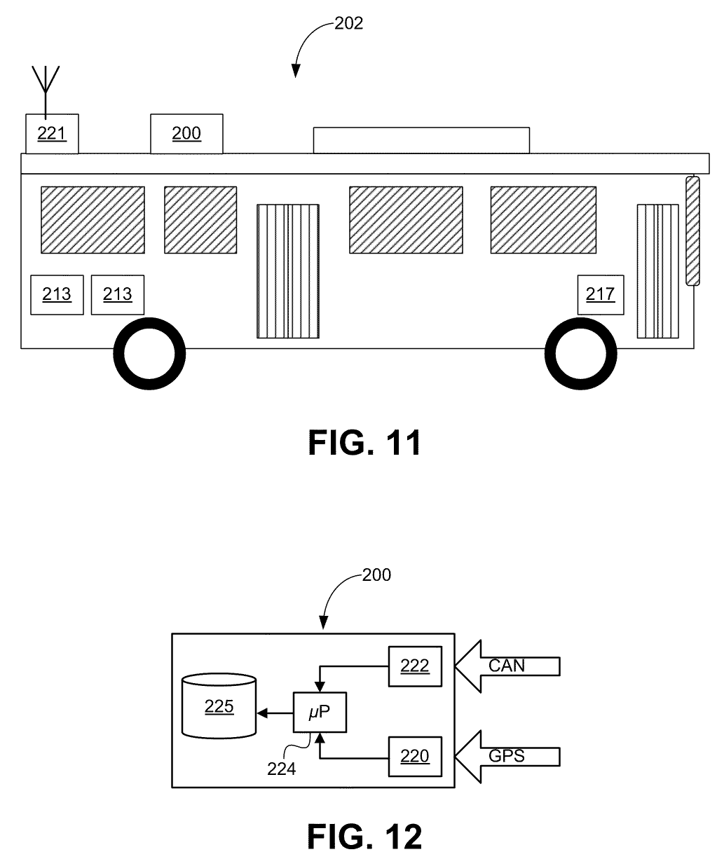

FIG. 11, illustrates a simplified schematic of one embodiment of a location based hybrid vehicle data logging and diagnostic system 200. As illustrated, the heavy-duty hybrid-electric or electric vehicle 202 includes an location based hybrid vehicle data logging and diagnostic system 200 for recording hybrid drive data and identifying vehicle faults of one or more components or sub-systems 213 of the hybrid drive system 101 and/or components or sub-systems 217 of the vehicle 202. The hybrid vehicle data recording system (or data logger) 200 may be implemented as a stand alone device (as illustrated), in a computer (e.g., hybrid drive control unit), or other device having recording and/or processing capability (e.g., a vehicle telemetry device or remote diagnostic unit). Preferably, data logger 200 is an onboard device and serves a similar function as data storage 25 of FIG. 4A. However, data logger 200 may be a remote device similar to data storages 35 and 45 of FIG. 3A

The hybrid drive components and sub-systems 213 may include an engine, generator, rooftop cooling, high voltage DC-DC inductor, remote diagnostic unit, vehicle energy storage, voltage protection module, drive motor, control system, electrically driven accessories, inverters, solid state alternators, etc., as partially illustrated in FIG. 1. As discussed previously, hybrid drive operation communications or information can be transmitted from the various hybrid drive sub-systems 213 and communicated over a vehicle communication network, such as a controller area network (CAN). Similarly, the vehicle components and sub-systems 217 may include brakes, doors, safety devices, fire system, hydraulic system, pneumatic system, suspension system, mechanical systems, electrical and lighting systems, and resident systems hosted by the vehicle. Vehicle operation communications or information can be transmitted from the vehicle sub-systems 217 and/or their controllers and associated sensors over a vehicle communication network as well.

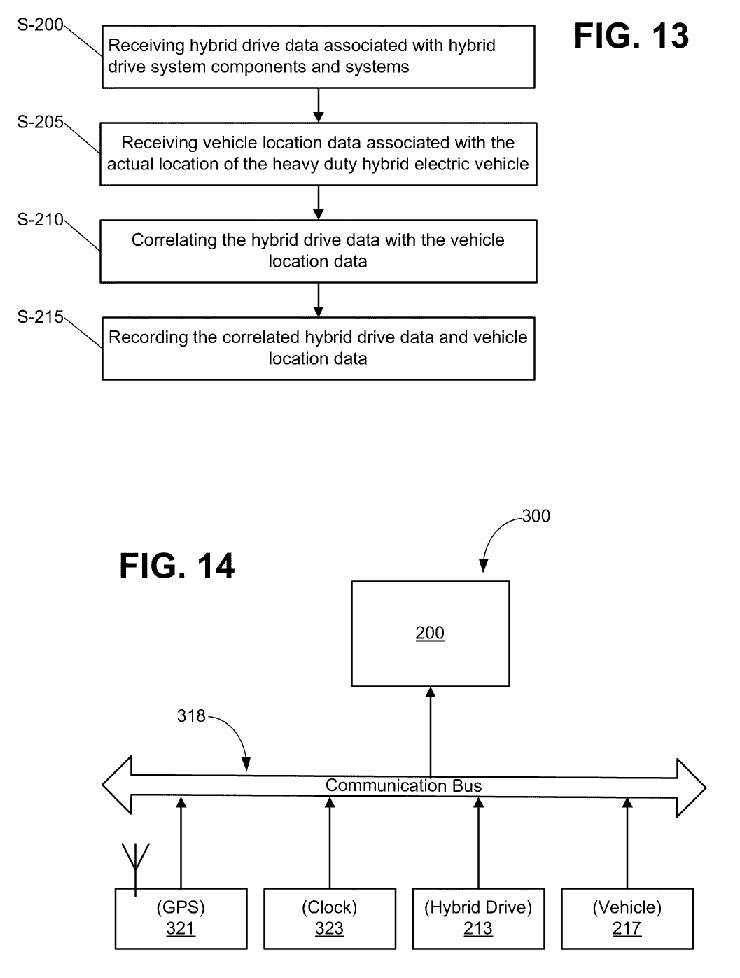

In operation, the hybrid vehicle data logging device 200 may record vehicle communications communicated over a vehicle communication bus or network 318 (described in FIG. 13 below), similar to the RDU 20 in FIG. 4A, for example. In addition, data logger 200 is configured to receive certain vehicle location data associated with the actual location of the heavy duty hybrid electric vehicle 202. Vehicle location data may be obtained from a location finder 221 such as a Global Positioning System (GPS) device. It is understood that data logger 200 may receive vehicle location data from any number of devices, some of which may be integrated into other host devices such as a vehicle telemetry device, a remote diagnostic unit (RDU), and/or the data logger 200 itself.

In some embodiments, the hybrid drive system data may be transmitted directly to the data logger 200 or over a vehicle communication bus to the data logging device 200. Alternately, the hybrid drive data may be transmitted wirelessly to the data logging device 200. Likewise, the vehicle location data may be transmitted via a direct link to the data logger 200 or indirectly, over a vehicle communication bus to the recording device 200. Also, alternately, the vehicle location data may be transmitted wirelessly to the data logging device 200. Where the hybrid vehicle data logging device 200 is not onboard the vehicle, an onboard device (e.g., RDU 20 of FIG. 3A) may create data files and wirelessly transmit the data to be recorded to the remote data storage 35, 45.

According to one embodiment and as described immediately above, the location finder 221 may include a transmitter configured to transmit location information over a vehicle communication bus, as opposed to sending it directly to the system 200. Since a vehicle communication bus will typically adhere to a standardized communication protocol (e.g., CAN, SAE J1939, LIN, FlexRay, etc.), the transmitter may include a processor configured to convert vehicle location information (e.g., GPS data) into standard-compliant messages. In this way, location information may be placed directly in the hybrid drive communication bus data stream. In this embodiment, location messages may also serve as breaks or markers in a resultant data log file of communication bus data.

FIG. 12 is a simplified schematic of an embodiment of system 200 for recording hybrid drive system data in a heavy duty hybrid electric vehicle. As illustrated, data logger 200 has a first receiver 222 configured to receive hybrid drive data, a second receiver 220 configured to receive vehicle location data, a controller 224 (e.g., a microprocessor) configured to correlate the hybrid drive data with the vehicle location data, and a memory 225 configured to record the correlated hybrid drive data and vehicle location data. As with the RDU 20 of FIG. 3A, receivers 220, 222 and/or processor 224 may sample down messages to be recorded. For example, message sampling may be determined based on a predetermined message rate (e.g., record every nth message, record message every n seconds, etc.). Alternately, message sampling may be determined based on message content (e.g., record only after message value changed by a predetermined value).

FIG. 13 is a flow chart of an exemplary method for recording hybrid drive data in a heavy duty hybrid electric vehicle. The method can be implemented in the location based hybrid vehicle data logging device 200 of FIGS. 11 and 12 above. At block (S-200), the process starts with receiving hybrid drive data associated with hybrid drive system components and systems. The hybrid drive data may be received over a vehicle communication bus. The hybrid data may also include vehicle data and resident device data. In addition, the received data may include samples of messages communicated over the vehicle communication bus. At block (S-205), the process continues with receiving vehicle location data associated with the actual location of the heavy duty hybrid electric vehicle. From there, at block (S-210), the hybrid drive data and the vehicle location data are correlated with each other, and at block (S-215), the correlated hybrid drive data and vehicle location data is recorded in the data logging device.

Correlating messages (S-210) may turn on the manner in which the messages are recorded (S-215). In particular, message correlation may depend on whether the status messages and location messages are recorded together or separately. For example, where both messages are recorded together (e.g., in a single file), the location messages may be interspersed chronologically between the vehicle/drive messages. This may be done manually using processor 224, wherein the processor 224 may re-write the vehicle/drive data to include the location information. Or alternately, as discussed above, this may be done conveniently by transmitting the location messages over the communication bus 318 such that location messages are automatically recorded based on when they are transmitted.

Somewhat similarly, where both messages are recorded together, but retain their respective identity, (i.e., a single file characterized by, for example, CAN messages and GPS location data), the location data may still be interspersed between the vehicle/drive data. However, here the location data may strategically delimit the file. For example, being separate, location data may only be written at the beginning of each file or data packet. In the alternate, location data may be advantageously only recorded at predetermined time intervals so as to represent both a location and time marker.

In the alternate, where both messages are recorded separately, they may require more direct correlation. In particular, in this case, a third file or index may be created to provide pointers or other indicia of what location corresponds to certain recorded vehicle/drive data. According to one embodiment, processor 324 may record clock information (see FIG. 14 item 323) such that both the location data file and the vehicle/drive data file both refer to the same time reference and are thus correlated in this way. This may be particularly useful when using third party troubleshooting software applications that are limited to reading/analyzing, for example, only CAN data files.

FIG. 14 is a simplified schematic of an embodiment of a heavy-duty hybrid-electric vehicle communication network 300, illustrating the location based hybrid vehicle data logging system 200. The electric vehicle communication network 300 includes the data logging system 200 and multiple sources of vehicle communications (e.g., a positioning module 321, a timing module 323, hybrid drive sub-systems and components 213, and vehicle sub-systems and components 217), all of which may be communicably coupled to vehicle communication bus 318. As with the communication bus 18 of FIG. 3A, it is understood that communication bus 318 may include multiple communication buses and networks. Also, it is understood that certain sources of vehicle communications (e.g., positioning module 321 and timing module 323) may be in direct communication and/or integrated with data logging system 200.

Referring to FIGS. 11-14 together, the positioning module 321 is configured to receive location information from a positioning system such as, but not by way of limitation, a Global Position System (GPS). The positioning module 321 may be a receiver or a computer system configured to receive GPS data or location information from the GPS. The positioning module 321 may be independent of the location based system 200 or integrated in the location based system 200. When the positioning module 321 is independent of the location based system 200, the location based system 200 may receive multiple position locations from the positioning module 321 via the network communication bus 318, for example.

The timing module 323 receives or provides timing information to the vehicle communication network 300. In some embodiments, the timing module 323 is a clock or a computer device configured to receive or generate timing information. The location based system 200 receives timing information from the timing module 323. The timing module may be integrated in the system 200 or a component thereof. The timing information may be used to time stamp the vehicle communication or information to indicate the time the vehicle information was received and/or sent to the system 200. Thus, the vehicle communication may include multiple position locations of the vehicle, timing information associated with the multiple position locations and vehicle operation information. The vehicle operation information is associated with the timing information and the multiple position locations such that the location of the vehicle at the time the vehicle operation information is received can be later determined. According to an embodiment, GPS data may be received on a 1 sec update rate, and a time marker or timing information is incorporated into the GPS data. Accordingly, as a default, for example, the system 200, stores GPS data or positioning information at that time marker.

As discussed above, where CAN data and GPS data are recorded together, the GPS data can be interspersed between the CAN data. In one embodiment, the GPS data is downsampled every 2 sec, 4 sec, etc. to reduce the size of the recorded data log (vehicle communication such as time stamp, communication address, message, etc.).

According to another embodiment, the data log or vehicle communication log may include a static GPS marker. The static GPS marker is a reference position such that after a given change in a parameter from the reference position the GPS information or data is updated. Accordingly, the hybrid drive data might only be correlated, for example, with a received vehicle location data, upon the condition that vehicle location data has changed by more than a predetermined threshold. For example, in some embodiments, the parameter is distance travelled, and the GPS marker is updated based on predetermined change of distance (e.g., every 300 feet). In other embodiments, GPS information or data may be updated and/or correlated based on a time out implementation as well (e.g., even if the vehicle hasn't moved, GPS still updated after 10 sec).

Similar to the processor 24 of FIGS. 3A and 4A, the hybrid vehicle data logging system 200 may sample or otherwise limit the number of messages recorded. Sampling may be performed by the datalogger itself, for example, via its processor 224, or by an associated device such as the RDU 20 of FIG. 4A. It is understood that data logging system 200 is illustrated as a separate unit for illustration, but will preferably be integrated with the RDU 20, wherein several illustrated components may be the same (e.g., processor 24 and processor 224). Message sampling may be directed toward all or certain CAN messages, GPS messages/signals, or any combination thereof. Also, as discussed above, rather than recording multiple instances of nearly identical data (e.g., a constant energy storage state of charge (SOC)), sampling may only include data when it varies by a threshold amount, at predetermined intervals, and/or as a fraction of a total transmission. Preferably, where sampling is employed, certain messages may never be disregarded. For example, failure/fault flags and other signals/messages serving similar reporting functions will generally not be filtered/sampled. Sampling should be used primarily to reduce duplicative and otherwise redundant data from being recorded, but not highly relevant data laden messages.

As discussed earlier, when a user or troubleshooter receives a report of a potential vehicle fault from a driver, they usually try to find out when and in which component/subsystem the fault arose. In troubleshooting problems with a vehicle, the troubleshooter often relies on the driver's recollection of what happened and/or when it happened. Up to now, troubleshooters often had to sift through a lot of data recorded over an extended time period to find an actual event or combination of irregular conditions. This may be less laborious in some cases, for example when the troubleshooter is looking for the occurrence of a specific event, for example the first occurrence of a persistent fault light coming on. Other times it is not so easy, for example if the driver simply reports that “the engine made a weird noise”. This may be caused by any number of vehicle components, making it hard to identify which component may be faulty from the extensive logged data. Thus, previous trouble shooting techniques were often inadequate and very time consuming. However, employing the location based data logging system 200 described above provides for more efficient troubleshooting and location based diagnostics. This is highly beneficial for complex, communication dominant electric drive systems found in modern hybrid-electric vehicles.

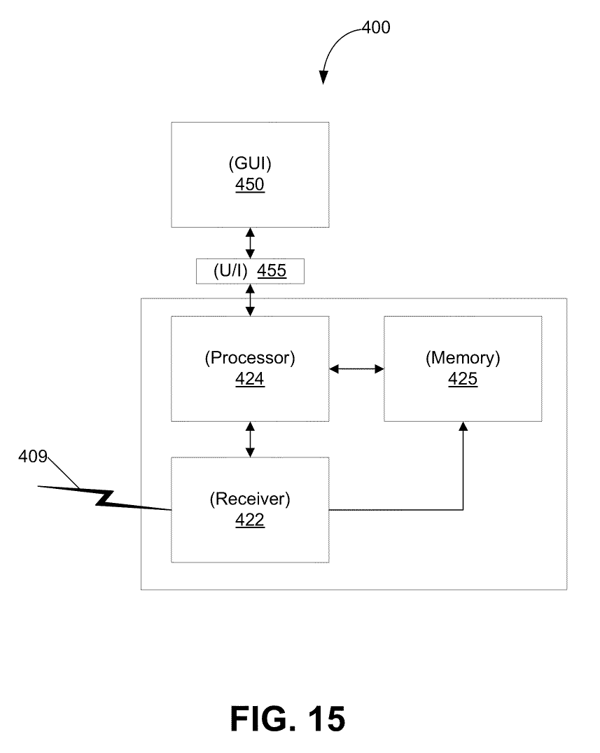

FIG. 15 illustrates a functional schematic diagram of a location based vehicle diagnostic system (“user device”) 400 configured to interact with the location based data logging system 200 described above, or a similar data storage. The location based vehicle diagnostic system 400 may be used for reviewing vehicle/drive system data and/or identifying vehicle faults. Preferably the location based vehicle diagnostic system 400 is used in conjunction with a hybrid-electric vehicle, but may also be used in other types of vehicles. The “user device” 400 includes a storage module (“Memory”) 425 in which hybrid drive data and vehicle location is recorded, a user interface (“U/I”) 455 configured to receive a geographical request, and an analysis module (“Processor”) 424 configured to determine and report a subset of the hybrid drive system data in response to the geographical request. The storage module 425 may be any appropriate memory device, and accompanying software drivers and interconnection, configured to store data logs from the vehicle. The user interface 455 may include common devices such as keyboards, computer mouse, touch screen, etc. The user device 400 may reside on the vehicle, or may be remote from the vehicle, i.e., similar to and/or integrated with a remote diagnostic user device 40 (FIG. 6).

Additionally, one or more of the components of user device 400 may be physically separated from the device 400 and reside in a portable second device (not shown) that is used to perform the manual download. For example, a wireless, volatile memory device may be configured to communicably link with the vehicle, download the drive system and location data, and then communicably link directly to the processor 424. Thus, this portable second device may either download to the user device's memory 425, or function as the user device's memory 425.

When user device 400 is configured as a remote diagnostic system, the analysis module or processor 424 will need to acquire both the hybrid drive system data and location data from the vehicle. Accordingly, user device 400 may include a communication port/module (“receiver”) 422 that is configured to receive hybrid drive data and vehicle location data from the hybrid vehicle. According to one embodiment, the hybrid drive data and vehicle location data may be manually downloaded from the location based data logging system 200. For example, in this case receiver 422 may include a manual download port such as an USB flash drive interface, a wireless (e.g., WiFi link), or the like.

Also, when user device 400 is configured as a remote diagnostic system, while manual download is possible, electronic data acquisition is preferred. As illustrated, communication module or receiver 422 may communicate over a communication link 409 with the vehicle and/or an intermediate server at a central control station, as discussed above. Communication link 409 may include a wireless portion as well. To illustrate, according to one embodiment, user device 400 may include a communications link analogous to remote diagnostic user device 40 (FIG. 6) wherein receiver 422 may receive real time data, vehicle datalogger files, or a combination of both. In either case, it advantageously becomes unnecessary to manually download data from the vehicle to memory 425 when receiver 422 is configured to download it electronically. Moreover, according one alternate embodiment, memory 425 may become optional by using an onboard vehicle memory in its stead and by transmitting the drive and location data directly from the vehicle to processor 424 via receiver 422.

Preferably, user device 400 will include a graphical user interface (“GUI”) 450 configured to report or display both the drive system data to be reviewed and geographical information associated with the vehicle location data. The GUI 450 may also display multiple position locations of the vehicle in conjunction with time information of when the vehicle was there. The GUI 450 may be any suitable display device such as a LCD, CRT, or other monitor. Moreover, U/I 455 may be integrated into GUI 450 using, for example, a capacitive touch screen.

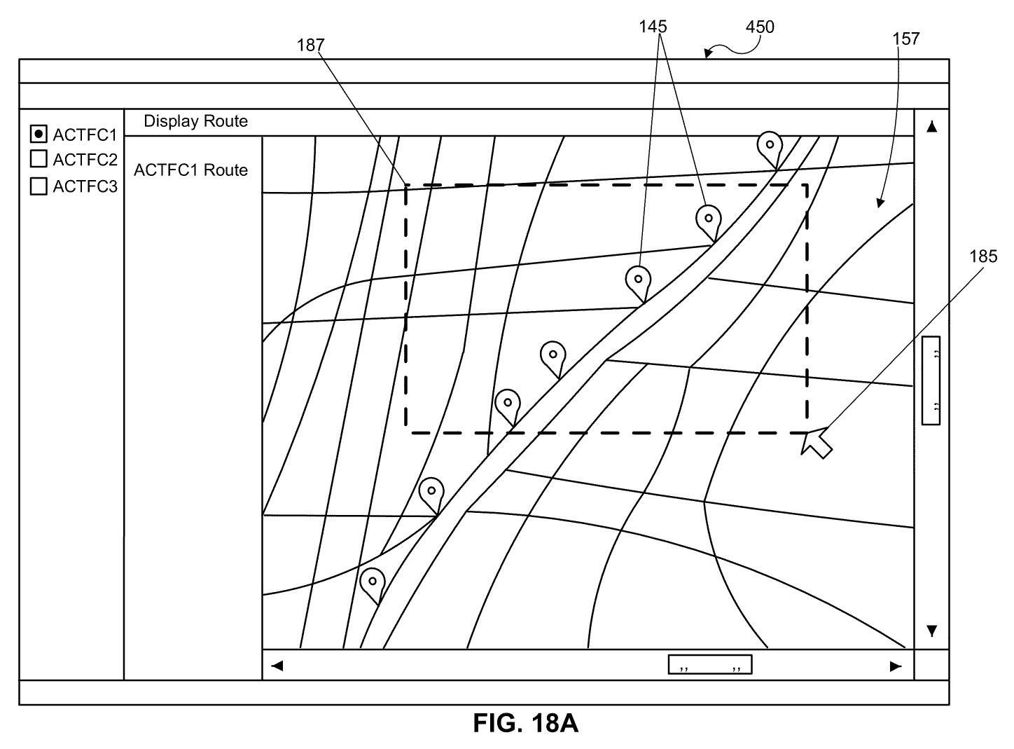

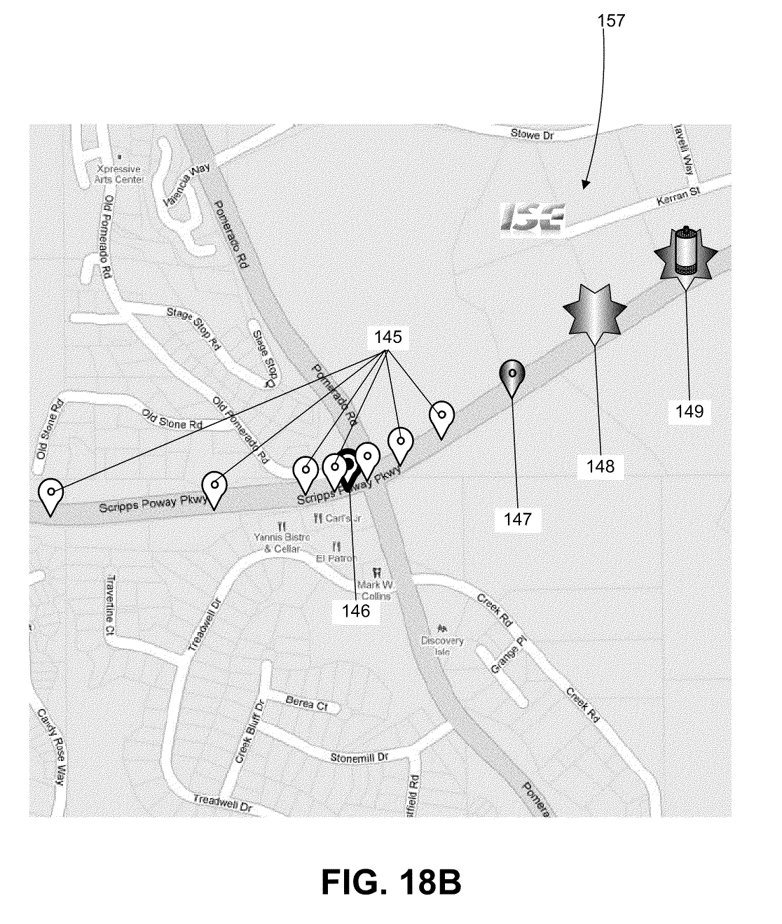

With regard to with the vehicle location data, the GUI 450 may be configured to provide a selection range of geographical information for the user's geographical request. In particular, GUI 450 may identify and display a selection range encompassing all or part of the locations recorded by the vehicle location data. For example, referring to FIG. 18A, a selection range may include map 157 superimposed with a series of vehicle location points 145 corresponding to a predetermined vehicle route or the vehicle's actual route. Where the vehicle location points correspond to the vehicle's actual route, processor 424 may generate these points from the vehicle location data stored in memory 425. Where appropriate, these data points may be downsampled for aesthetic purposes when displayed on GUI 450. In the alternate, discrete data points may be extrapolated to generate a continuous path of travel.

Where time information is available, it may be included in the display of the vehicle location data as well. In particular, the U/I 455 may be further configured to receive a time request from the user. In response to the time request, the GUI 450 may then display a subset of the vehicle location data, and/or drive system data. This may be particularly useful in making an “initial cut” of the vehicle location data and/or drive system data. Likewise, if the vehicle has passed the same location more than once, a time selection option may be provided with each time that vehicle was at the same location. The time selection option may afford selection of one set of times among the plurality of sets of times the vehicle was at the same location.

Once the vehicle location data is provided to the user, the GUI 450 may interact with the U/I 455 such that the user can make the geographical request from the displayed geographical information. For example, referring to FIG. 18A, the user may click one or more points 145 on a map 157 representing actual vehicle location points, or may even select within a vicinity of a desired vehicle travel location. The selection may then serve to delimit a portion of the drive system data to report.

According to another embodiment, if the location data requested (e.g., from an erroneous driver report) falls outside actual vehicle-reported GPS data, the user device 400 may assign a closest match (or correlation) in the data logger data (e.g., by correlating the selection to a time, and outputting a desired range of recorded data based on that estimated time). To illustrate, if a user selects a point on a GUI map that does not coincide GPS data of the vehicle, the processor 424 may determine the nearest actual GPS point or extrapolated GPS point and reassign the geographic request accordingly. However, there still may be a range that the request has to fall within, in order not to be rejected altogether. Whether the user operated the U/I 455 to select a single point of interest, several points, or an estimated point, the user device 400 may associate this geographical request with an event window, as discussed below.

Alternately, rather than focusing on discrete points/locations, the GUI 450 and U/I 455 may operate to allow user to select a range of vehicle location data. In particular, referring to FIG. 18A, the range can be defined by dragging a box 187 around a correlated position location or an area of interest using a cursor 185. For example, in practice, a driver may remember that “he passed the Ted Williams Parkway off ramp on the southbound 15 freeway”, but failed to recall “reaching the Scripps/Poway Parkway off ramp,” so the event “must have been somewhere between.” This location information provided by the driver, while not exact, can still be correlated with a position location or location information on the map. In this case, the box can be dragged around the “15 freeway south” between these two exits (e.g., using a mouse). Thus, all vehicle location data falling within the selected boundaries may form the geographical request. Alternately, the U/I 455 may act directly with GUI 450, such as where the vehicle route is actually displayed or superimposed on a map and a selection of at least a portion of the route can be made. The selection of the route could then be made by a troubleshooter by using, for example, an interactive device such as a light pen or a capacitive touch wand.

According to one embodiment, the geographical information associated with the vehicle location data may also include then current environmental conditions proximate the hybrid-electric vehicle. For example, in addition to vehicle location data, GUI 450 could also display landmark data and/or be integrated with third party specialized maps such as Google Street View, of Google Incorporated, to improve the correlation between one or more reported events with the one or more position locations of the vehicle. For example, if the driver reports that that a noise was heard first while the vehicle was in front of a Home Depot on Scripps/Poway Parkway East and that the noise stopped when the vehicle was in front of Carl's Jr. fast food restaurant, this information would normally have very limited value for troubleshooting. However, in combination with “Google Street View,” for example, this information can be correlated with actual physical locations, and in turn with actual vehicle location data. Moreover, this information, which would otherwise have no or limited use, with may now provide a 30 second window for review or analysis (this calculation is based on the assumption that the vehicle was traveling approximately at the 30 mph speed limit, and the distance between both locations is approximately 1300 feet).

Also, for example, UI 450 may incorporate specialized maps including terrain topography and/or traffic conditions. This may be valuable when troubleshooting an energy storage event that is associated with the environment of the vehicle. For example, downhill sections or intersections may be associated with regenerative braking, and uphill sections may be associated with generator demands, both implicating energy storage charge or discharge. Thus, with this additional environmental information, a trouble shooter investigating a failure or overtemp condition on a drive motor inverter, for example, could further limit the geographical request to a portion of the vehicle's route that corresponded with vehicle braking (e.g., downhill or approaching traffic).

As discussed above, in some embodiments an event window may be created. In particular, the processor or controller 424 of user device 400 may respond to a user input and set a first time of the first geographical request location, based on a GPS reading that is selected or that begins a selection range, and, where applicable, a second time of a second location selected or ending a selection range. These first and the second times can then be used to define an event window based on time and or location. In particular, the event window defines the geographical request as those vehicle location data occurring within a predetermined time before and after the vehicle location point request, and/or as all those vehicle location data occurring within a predetermined distance before and after the vehicle location point request.

Furthermore, whether one or more locations of interest are indicated, the event window may be extended beyond the limits of the geographical request fault. For example, when the driver or user makes the geographical request for the vehicle data, the location based data logging system 200 may provide time stamp information for the location(s), and processor 424 may then determine an extended range for the requested data (e.g., 15 sec and/or 300 feet before and after time stamp(s) of the reported location(s) of the geographical request). Even though it extends the range of the data to be provided, the event window is typically much smaller than if the driver was asked to provide a time range in the first instance. Preferably, an extended time range of the event window would be determined based on the type of fault that occurred and/or the speed of the vehicle. In particular, if the subsystem that triggered the fault has a relatively short response time, the event window may be only extended by a short amount whereas longer response times of the subsystem would lead to a broader extended time range. Similarly, where the vehicle is traveling faster at a border of the event window, the predetermined distance may be greater than if the vehicle had been going slower.

According to one alternate embodiment, location based vehicle diagnostic system 400 may configure its GUI 450 to provide key status information associated with one or more vehicle location points. In doing so, the user may better refine the geographical request. “Key status information” may be defined broadly, as above (i.e., any partial HEV messaging), however, it will preferably be limited to just a few items, in order to facilitate presentation of the vehicle's location data on the GUI 450. In particular, where multiple discrete location points are used, each point may report one or two additional pieces of information such as a fault flag, a time, a speed, an energy storage status, a high voltage isolation status, etc. According to one embodiment, rather than listing out the additional data as text, the means for identifying the HEV's location may be modified to provide the information pictorially. For example, vehicle location may be displayed using icons that, when used with a legend, identify the additional information.

As illustrated in FIG. 18B, GUI 450 displays geographical information associated with the actual, recorded vehicle GPS data of a vehicle. According to this embodiment, the individual icons 145, 146, 147, 148, 149 are shown on map 157, and represent vehicle locations taken at 500 ms intervals. The varying distances between icons indicate vehicle speed. For example, the distance between the two location points furthest to the left corresponds to approximately 30 mph. In addition, unshaded (or green) round icons 145, 146 represent the vehicle is operating fine, whereas the various subsequent icons 147, 148, 149 by virtue of all being shaded (or red), may indicate the presence of a fault flag (e.g., similar to a check engine light). Bold icon 146 represents that multiple points are co-located and thus the vehicle is stopped. Next, icon 147 may be round and red, indicating a general fault flag. Next, icon 148 may be both red and star shaped, with the star indicating the high voltage system is out of isolation tolerance. Finally, icon 149 may be red, star shaped, and include a low battery icon, with the low battery icon indicating that the propulsion energy system state of charge (SOC) is at or below its low SOC threshold. When read together, a trouble shooter may be able to quickly identify that the vehicle stopped at an intersection and upon a somewhat aggressive acceleration lost high voltage isolation. Given that that vehicle had just come to a long stop, thereby charging the energy storage, the low SOC condition at point 149 would be premature and may suggest that the energy storage was shorted rather discharged via vehicle acceleration. Where the geographical request is limited to single points, the troubleshooter would immediately request point 147 as the point of interest. Where the geographical request includes a selection range, the troubleshooter would immediately request the range between right-most point 145 and point 149 as the range of interest of interest. Without this key status information, the driver may report that the vehicle failed further down the road, if at all, but with this key status information displayed, the user may select an event window of 1.5 seconds.

According to one preferred embodiment, the user may select which key status information is provided. In particular, GUI 450 may display to a user key status information that is available and the U/I 455 is further configured to receive a key status information request. Accordingly, the key status information would then be selected responsive to the key status information request. In this way, the location based vehicle diagnostic system 400 becomes highly interactive with the user, and a troubleshooter may rapidly reduce an event window by strategically selecting key status information sources that are closely linked to a reported condition or the initial stages of the reported condition.

As with the interactive selection of key status information above, the location based vehicle diagnostic system 400 may also provide for selection of available data sources associated with the hybrid drive system data. In particular, GUI 450 may display available data sources to a user, where the U/I 455 is further configured to receive a data source request. Processor 424 will then filter the hybrid drive data according to the data source request. Accordingly, the reported subset of hybrid drive system data would then not only be limited by vehicle locations, but also would be by data source. In this way, the location based vehicle diagnostic system 400 becomes highly interactive with the user, and a troubleshooter may rapidly reduce an event window and a data log report by strategically selecting only data sources that are closely linked to a reported condition or the initial stages of the reported condition.

According to one embodiment, the data sources may be grouped by subsystem. For example, a user may limit reporting to a single subsystem such as Energy Storage, Generator, Drive Motors, Electrical Accessories, Inverters, etc. Given the large number of data sources onboard a typical hybrid vehicle, this embodiment advantageously allows the user to quickly eliminate multiple data sources that are not likely to be associated with the reported problem.

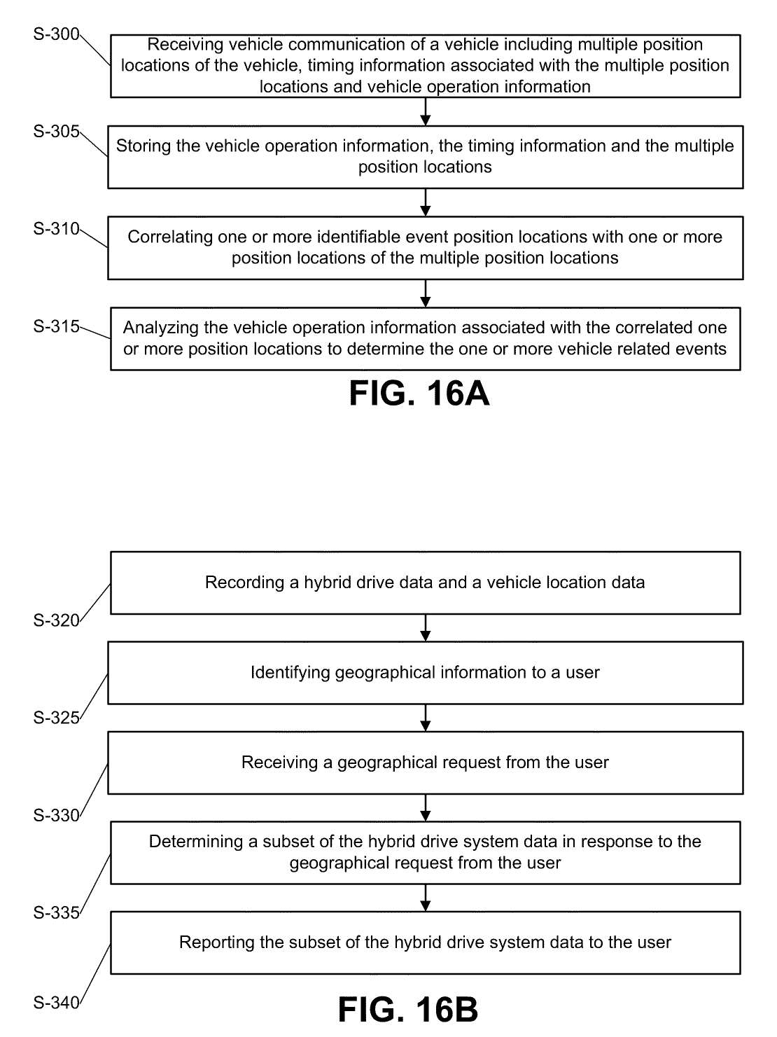

FIG. 16A is a flow chart of an exemplary method for reviewing vehicle data and identifying a vehicle fault. The method can be implemented in the location based data logging system 200 of FIGS. 11 and 12 above. At block (S-300), the process starts with receiving vehicle communication of a vehicle. The vehicle communication includes multiple position locations of the vehicle, timing information associated with the multiple position locations and vehicle operation information. The vehicle operation information is associated with the timing information and the multiple position locations such that the location of the vehicle at the time the vehicle operation information is received can be determined.

At block (S-305), the vehicle operation information, the timing information and the multiple position locations are stored in a storage device. The process then continues to block (S-310) where one or more identifiable event position locations are correlated with the one or more position locations of the multiple position locations and the vehicle operation information associated with the correlated one or more position locations are retrieved. The one or more identifiable event position locations are associated with the occurrence of one or more identifiable indications related to one or more vehicle related events. Finally in block (S-315) the vehicle operation information associated with the correlated one or more position locations are analyzed to determine the one or more vehicle related events.

FIG. 16B is a flow chart of an exemplary method for remotely diagnosing a hybrid drive system in a hybrid-electric vehicle. The method can be implemented in the remote diagnostic system 400 of FIG. 15 above. At step (S-320), the process starts with recording hybrid drive data and vehicle location data. Next, at step (S-325), the user is provided with geographical information. Next, at step (S-325), the method includes receiving a geographical request from the user. Next, at step (S-330), a subset of the hybrid drive system data is determined in response to the geographical request from the user. Next, at step (S-335) a subset of the hybrid drive system data is determined in response to the geographical request from the user. And finally, at step (S-340) the subset of the hybrid drive system data is reported to the user.

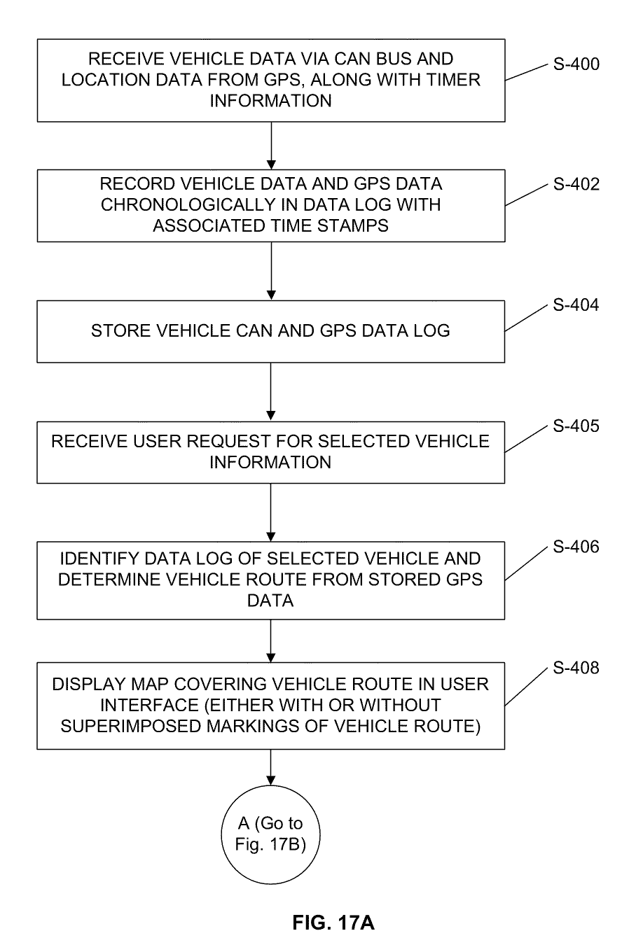

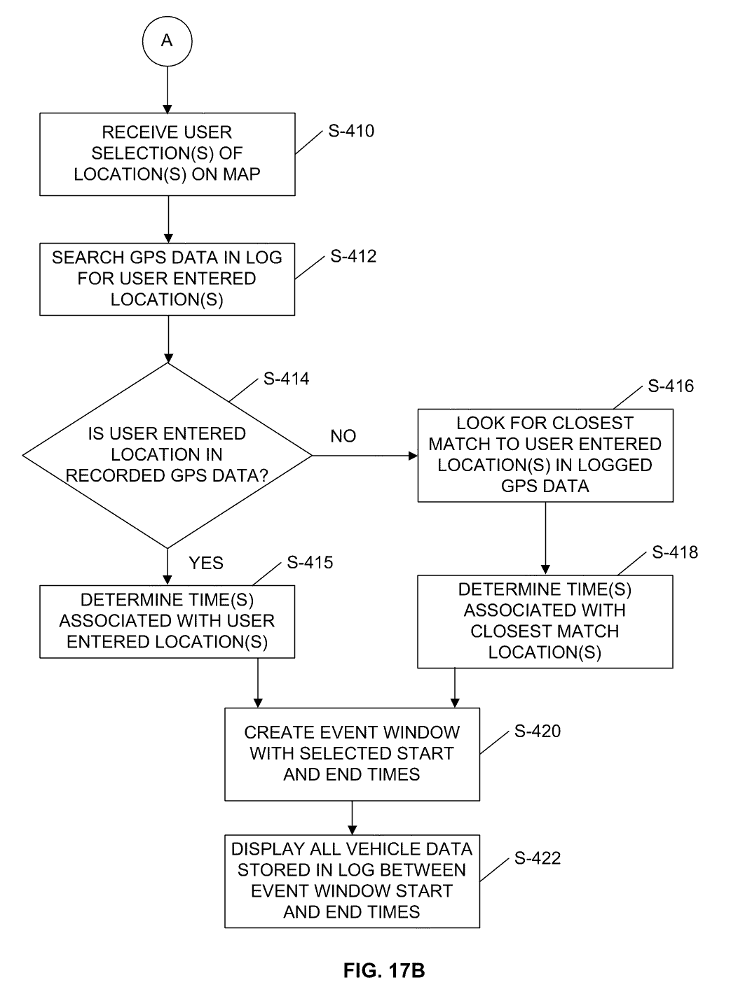

FIG. 17A illustrates one exemplary embodiment of a method for collecting and storing CAN and GPS data chronologically in a data log, and for displaying selected portions of the CAN data to a user in GUI 450. At step (S-400), the method begins on the vehicle where the data logger module 25 of FIG. 4A continuously or periodically receives vehicle data over the CAN bus 18 and vehicle position or location data from the GPS unit 21. At step (S-402), the method correlates the received CAN and GPS data by time of receipt, or other means, and records the correlated CAN and GPS data in a data log, preferably including periodic time stamps. Different data logs may be stored for each trip or route traveled by the vehicle. Also, as noted above, GPS data may be down sampled and recorded at periodic intervals of e.g., 500 ms, 1 s, 2 s, 4 s, etc., depending on the desired size of the recorded data log. Alternatively, the data log may include a GPS marker which is updated based on change of distance (e.g. every 300 feet). This may default to a time out update, for example update the GPS after ten seconds even if the vehicle has not moved. At step (S-404), the vehicle CAN and GPS data is stored in a suitable data storage unit or medium. This data may be stored at the vehicle and provided periodically in messages to the remote server, where it is stored in data storage module 35 (FIG. 3A) along with a vehicle identifier.

As discussed above, a troubleshooter responding to a vehicle event may begin by obtaining additional information from the driver, which may be helpful in pinning down a more exact time when the reported event occurred. Specifically, the troubleshooter may ask the driver where the vehicle was located when the event occurred. As above, often, a driver remembers where they were when something happened more accurately than they remember the time of the event. For example, they may remember that they had just passed a certain freeway off ramp or were between two off ramps, or that they were near to a certain landmark such as a hospital, school, mall, or the like. With this information, the troubleshooter or user requests the stored data log for the vehicle of interest using user device 400 (FIG. 15). The method continues at step (S-405) with a request to the server for stored information on that vehicle. The vehicle's route can be determined from the sequence of GPS location data stored in the log (S-406), and a map covering the vehicle route is displayed on the user interface (S-408). The map may simply be a map covering the area of interest, or may include superimposed markings of the vehicle route, for example discrete GPS points as indicated in FIG. 18A, or a marked path of the vehicle route.

FIG. 17B continues on with a method of obtaining logged vehicle data, and of the hybrid system in particular. As discussed above, the user may identify a single location on the displayed map, or may identify an range between two locations where the driver is unsure of the exact location when the event occurred. The method continues at step (S-410) with the processor 424 receiving a geographical request via U/I 455, and then at step (S-412) with a search of the data log to find the location(s) entered by the user. If it is determined in (S-412) that the vehicle has passed the same location more than once, a selection option may be provided, where the user or troubleshooter is given each set of times when the location was passed, and may selected one set for display of associated vehicle data. In this case, the user may first ask the driver which of the times corresponds most closely to the time period in which the vehicle event occurred.

A decision is then made whether the user-entered location corresponds to actual recorded vehicle location data (S-414). If the user selected location is found in the recorded GPS data, the time associated with the entered location, or the times associated with the two end locations when the user entered more than one location, may be determined from the data log (S-415). However, if the location or locations entered by a user in (S-410) are determined to fall outside the recorded GPS data in (S-412) and (S-414), the GPS data is searched in (S-416) for a GPS data point that is the closest match to the entered location (or the closest matches where two locations outside the recorded data are entered). Likewise, the time or times associated with the closest match GPS point(s) are then identified (S-418).

Independent of whether the user entered location matches actual recorded location data, the system is programmed to create an event window using the selected start time and end time associated with the time(s) associated with the entered location or location information (S-420). For example, where a single location is entered, the system is configured to select a predetermined time range around the time corresponding to the entered location (or around the time stamp associated to the closest match to that location when the entered location is outside the stored GPS data), and to create an event window corresponding to the selected time range. This allows an investigation to be made of what was happening to the vehicle before and after the reported event. In one embodiment, a five minute (or any other appropriate time period) event window around the time of the entered location may be created. Where two different locations about an event are entered by the user (i.e., a start and end location), the times associated with these locations may be used to determine the event window, or an extended time range may be determined, for example fifteen seconds before and after the time stamps of the user entered start and finish event locations.

Once an event window has been created, vehicle data within that time or event window may be reported or displayed using GUI 450 in any suitable manner (S-422). For example, in place of or alongside the map 157 in FIG. 18A. Where an extended event window is determined, i.e. extended to times before and after the time stamps corresponding to the selected start and finish locations, the system may identify the CAN data for the time range between the selected locations as well as the extended time range, and both sets of data may be displayed in the user interface.

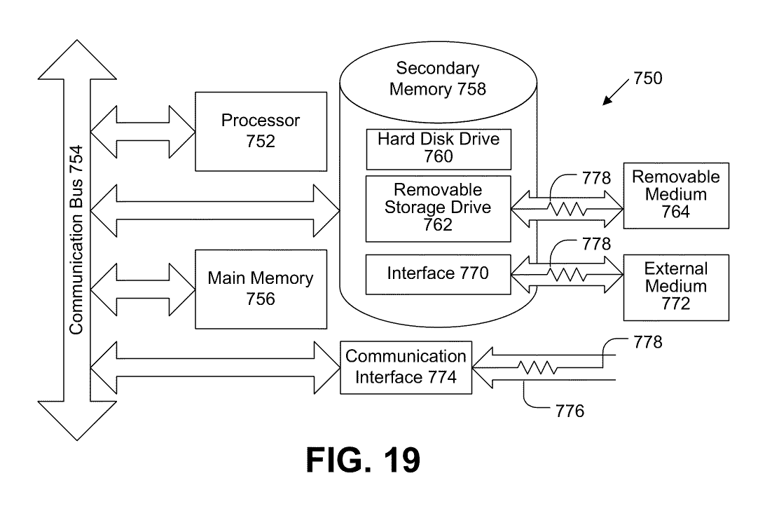

FIG. 19 is a block diagram illustrating an example computer system 750 that may be used in connection with various embodiments described herein. For example, the computer system 750 may be used in conjunction with the location based hybrid vehicle data logging and diagnostic system 200 previously described with respect to FIG. 12 or the location based vehicle diagnostic system 400 previously described with respect to FIG. 15. Other computer systems and/or architectures may also be used as will be understood by those skilled in the art.

The computer system 750 preferably includes one or more processors, such as processor 752. Additional processors may be provided, such as an auxiliary processor to manage input/output, an auxiliary processor to perform floating point mathematical operations, a special-purpose microprocessor having an architecture suitable for fast execution of signal processing algorithms (e.g., digital signal processor), a slave processor subordinate to the main processing system (e.g., back-end processor), an additional microprocessor or controller for dual or multiple processor systems, or a coprocessor. Such auxiliary processors may be discrete processors or may be integrated with the processor 752.

The processor 752 is preferably connected to a communication bus 754. The communication bus 754 may include a data channel for facilitating information transfer between storage and other peripheral components of the computer system 750. The communication bus 754 further may provide a set of signals used for communication with the processor 752, including a data bus, address bus, and control bus (not shown). The communication bus 754 may comprise any standard or non-standard bus architecture such as, for example, bus architectures compliant with industry standard architecture (“ISA”), extended industry standard architecture (“EISA”), Micro Channel Architecture (“MCA”), peripheral component interconnect (“PCI”) local bus, or standards promulgated by the Institute of Electrical and Electronics Engineers (“IEEE”) including IEEE 488 general-purpose interface bus (“GPIB”), IEEE 696/S-100, and the like.

Computer system 750 preferably includes a main memory 756 and may also include a secondary memory 758. The main memory 756 provides storage of instructions and data for programs executing on the processor 752. The main memory 756 is typically semiconductor-based memory such as dynamic random access memory (“DRAM”) and/or static random access memory (“SRAM”). Other semiconductor-based memory types include, for example, synchronous dynamic random access memory (“SDRAM”), Rambus dynamic random access memory (“RDRAM”), ferroelectric random access memory (“FRAM”), and the like, including read only memory (“ROM”).

The secondary memory 758 may optionally include a hard disk drive 760 and/or a removable storage drive 762, for example a floppy disk drive, a magnetic tape drive, a compact disc (“CD”) drive, a digital versatile disc (“DVD”) drive, etc. The removable storage drive 762 reads from and/or writes to a removable storage medium 764 in a well-known manner. Removable storage medium 764 may be, for example, a floppy disk, magnetic tape, CD, DVD, etc.

The removable storage medium 764 is preferably a computer readable medium having stored thereon computer executable code (i.e., software) and/or data. The computer software or data stored on the removable storage medium 764 is read into the computer system 750 as electrical communication signals 778.

In alternative embodiments, secondary memory 758 may include other similar means for allowing computer programs or other data or instructions to be loaded into the computer system 750. Such means may include, for example, an external storage medium 772 and an interface 770. Examples of external storage medium 772 may include an external hard disk drive or an external optical drive, or and external magneto-optical drive.

Other examples of secondary memory 758 may include semiconductor-based memory such as programmable read-only memory (“PROM”), erasable programmable read-only memory (“EPROM”), electrically erasable read-only memory (“EEPROM”), or flash memory (block oriented memory similar to EEPROM). Also included are any other removable storage units 772 and interfaces 770, which allow software and data to be transferred from the removable storage unit 772 to the computer system 750.

Computer system 750 may also include a communication interface 774. The communication interface 774 allows software and data to be transferred between computer system 750 and external devices (e.g. printers), networks, or information sources. For example, computer software or executable code may be transferred to computer system 750 from a network server via communication interface 774. Examples of communication interface 774 include a modem, a network interface card (“NIC”), a communications port, a PCMCIA slot and card, an infrared interface, and an IEEE 1394 fire-wire, just to name a few.

Communication interface 774 preferably implements industry promulgated protocol standards, such as Ethernet IEEE 802 standards, Fiber Channel, digital subscriber line (“DSL”), asynchronous digital subscriber line (“ADSL”), frame relay, asynchronous transfer mode (“ATM”), integrated digital services network (“ISDN”), personal communications services (“PCS”), transmission control protocol/Internet protocol (“TCP/IP”), serial line Internet protocol/point to point protocol (“SLIP/PPP”), and so on, but may also implement customized or non-standard interface protocols as well.

Software and data transferred via communication interface 774 are generally in the form of electrical communication signals 778. These signals 778 are preferably provided to communication interface 774 via a communication channel 776. Communication channel 776 carries signals 778 and can be implemented using a variety of wired or wireless communication means including wire or cable, fiber optics, conventional phone line, cellular phone link, wireless data communication link, radio frequency (RF) link, or infrared link, just to name a few.

Computer executable code (i.e., computer programs or software) is stored in the main memory 756 and/or the secondary memory 758. Computer programs can also be received via communication interface 774 and stored in the main memory 756 and/or the secondary memory 758. Such computer programs, when executed, enable the computer system 750 to perform the various functions of the present invention as previously described.

In this description, the term “computer readable medium” is used to refer to any media used to provide computer executable code (e.g., software and computer programs) to the computer system 750. Examples of these media include main memory 756, secondary memory 758 (including hard disk drive 760, removable storage medium 764, and external storage medium 772), and any peripheral device communicatively coupled with communication interface 774 (including a network information server or other network device). These computer readable mediums are means for providing executable code, programming instructions, and software to the computer system 750.

In an embodiment that is implemented using software, the software may be stored on a computer readable medium and loaded into computer system 750 by way of removable storage drive 762, interface 770, or communication interface 774. In such an embodiment, the software is loaded into the computer system 750 in the form of electrical communication signals 778. The software, when executed by the processor 752, preferably causes the processor 752 to perform the inventive features and functions previously described herein.

Those of skill will appreciate that the various illustrative logical blocks, units, modules, and algorithm steps described in connection with the embodiments disclosed herein can often be implemented as electronic hardware, computer software, or combinations of both. To clearly illustrate this interchangeability of hardware and software, various illustrative components, units, blocks, modules, and steps have been described above generally in terms of their functionality. Whether such functionality is implemented as hardware or software depends upon the design constraints imposed on the overall system. Skilled persons can implement the described functionality in varying ways for each particular application, but such implementation decisions should not be interpreted as causing a departure from the scope of the invention. In addition, the grouping of functions within a module, unit, block or step is for ease of description. Specific functions or steps can be moved from one module, block, or unit without departing from the invention.

Various illustrative logical blocks, units and modules described in connection with the embodiments disclosed herein can be implemented or performed with a general purpose processor, a digital signal processor (DSP), application specific integrated circuit (ASIC), a field programmable gate array (FPGA) or other programmable logic device, discrete gate or transistor logic, discrete hardware components, or any combination thereof designed to perform the functions described herein. A general-purpose processor can be a microprocessor, but in the alternative, the processor can be any processor, controller, microcontroller, or state machine. A processor can also be implemented as a combination of computing devices, for example, a combination of a DSP and a microprocessor, a plurality of microprocessors, one or more microprocessors in conjunction with a DSP core, or any other such configuration.

The steps of a method or algorithm described in connection with the embodiments disclosed herein can be embodied directly in hardware, in a software module executed by a processor, or in a combination of the two. A software module can reside in RAM memory, flash memory, ROM memory, EPROM memory, EEPROM memory, registers, hard disk, a removable disk, a CD-ROM, or any other form of storage medium. An exemplary storage medium can be coupled to the processor such that the processor can read information from, and write information to, the storage medium. In the alternative, the storage medium can be integral to the processor. The processor and the storage medium can reside in an ASIC.

The above description of the disclosed embodiments is provided to enable any person skilled in the art to make or use the invention. Various modifications to these embodiments will be readily apparent to those skilled in the art, and the generic principles described herein can be applied to other embodiments without departing from the spirit or scope of the invention. Thus, it is to be understood that the description and drawings presented herein represent a presently preferred embodiment of the invention and are therefore representative of the subject matter which is broadly contemplated by the present invention. It is further understood that the scope of the present invention fully encompasses other embodiments that may become obvious to those skilled in the art and that the scope of the present invention is accordingly limited by nothing other than the appended claims.

The system and methods of the above embodiments reduce troubleshooting time by allowing a time frame when a reported vehicle event occurred to be identified more accurately, based on the driver's recollection of the general location of the vehicle at the time of the event, rather than recollection of the actual time when the event occurred. Since less data has to be reviewed when the time frame can be more accurately isolated, this can significantly reduce the time for a troubleshooter to identify a potential source or fault which resulted in the event noticed by the driver, and thus to determine which part of the vehicle requires maintenance or replacement. The system is relatively inexpensive to implement, and allows for more accurate fault reporting.

1. A system for recording hybrid drive data in a heavy duty hybrid electric vehicle, the system comprising:
a first receiver configured to receive hybrid drive data;
a second receiver configured to receive vehicle location data;
a controller configured to correlate the hybrid drive data with the vehicle location data; and,
a memory configured to record the correlated hybrid drive data and vehicle location data.

2. The system of claim 1, wherein the first receiver is further configured to receive hybrid drive data communicated over a vehicle communication bus.

3. The system of claim 2, wherein the vehicle communication bus is a Controller Area Network (CAN) bus.

4. The system of claim 2, wherein the first receiver is further configured to sample hybrid drive data communicated over the vehicle communication bus.

5. The system of claim 2, further comprising a transmitter configured to transmit the received vehicle location data over the vehicle communication bus;
wherein the first receiver is further configured to receive the vehicle location data transmitted over the vehicle communication bus.

6. The system of claim 1, wherein the second receiver comprises a Global Positioning System (GPS) receiver.

7. The system of claim 1, wherein the vehicle location data is separate from the hybrid drive data, and wherein the first receiver is separate and distinct from the second receiver.

8. The system of claim 1, wherein the controller is further configured to intersperse the vehicle location data in the hybrid drive data.

9. The system of claim 8, wherein the memory is further configured to record the interspersed vehicle location data and hybrid drive data as a combined file.

10. The system of claim 1, wherein the controller is further configured to index the vehicle location data and the hybrid drive data to each other and/or to an independent reference.

11. The system of claim 10, wherein the memory is further configured to record the indexed vehicle location data and hybrid drive data as separate files.

12. The system of claim 1, wherein the memory includes a vehicle data storage device onboard the vehicle.

13. The system of claim 1, the memory includes a data storage device located remotely from the vehicle.

14. The system of claim 1, wherein the controller is further configured to cause the system to receive hybrid drive data, to receive vehicle location data, to correlate the hybrid drive data with the vehicle location data, and/or to recording the correlated hybrid drive data and vehicle location data responsive to the vehicle location data changing by more than a predetermined threshold.

15. A method for recording hybrid drive system data in a heavy duty hybrid electric vehicle, the method comprising:
receiving hybrid drive data associated with hybrid drive system components and systems;
receiving vehicle location data associated with the actual location of the heavy duty hybrid electric vehicle;
correlating the hybrid drive data with the vehicle location data; and,
recording the correlated hybrid drive data and vehicle location data.

16. The method of claim 15, wherein the receiving hybrid drive data comprises receiving hybrid drive data communicated over a vehicle communication bus.

17. The method of claim 16, wherein the vehicle communication bus is a Controller Area Network (CAN) bus.

18. The method of claim 16, wherein the receiving hybrid drive data communicated over the vehicle communication bus comprises sampling hybrid drive data communicated over the vehicle communication bus.

19. The method of claim 16, further comprising transmitting the received vehicle location data over the vehicle communication bus;
wherein the receiving vehicle location data includes receiving the vehicle location data transmitted over the vehicle communication bus.

20. The method of claim 15, wherein the receiving vehicle location data comprises receiving Global Positioning System (GPS) data.

21. The method of claim 15, wherein the vehicle location data is separate from the hybrid drive data, and wherein the vehicle location data is received separately from the hybrid drive data.

22. The method of claim 15, wherein the correlating the hybrid drive data with the vehicle location data comprises interspersing the vehicle location data in the hybrid drive data.

23. The method of claim 22, wherein the recording the correlated hybrid drive data and vehicle location data comprises recording the interspersed vehicle location data and hybrid drive data as a combined file.

24. The method of claim 15, wherein the correlating the hybrid drive data with the vehicle location data comprises indexing the vehicle location data and the hybrid drive data to each other and/or to an independent reference.

25. The method of claim 24, wherein the recording the correlated hybrid drive data and vehicle location data comprises recording the indexed vehicle location data and hybrid drive data as separate files.

26. The method of claim 15, wherein the recording the correlated hybrid drive data and vehicle location data comprises recording the correlated hybrid drive data and vehicle location data in a vehicle data storage device onboard the vehicle.

27. The method of claim 15, further comprising transmitting the hybrid drive data and vehicle location data to a location remote from the vehicle;
wherein the recording the correlated hybrid drive data and vehicle location data comprises recording the correlated hybrid drive data and vehicle location data in a remote data storage device away from the vehicle.

28. The method of claim 15, wherein the one or more of the receiving hybrid drive data, receiving vehicle location data, correlating the hybrid drive data with the vehicle location data, and recording the correlated hybrid drive data and vehicle location data is conditioned upon the vehicle location data changing by more than a predetermined threshold.

29. A hybrid electric vehicle comprising:
a communication bus configured to communicate hybrid drive data;
a location device configured to determine vehicle location data;
a hybrid vehicle data logging device including a first receiver configured to receive hybrid drive data, a second receiver configured to receive vehicle location data, a controller configured to correlate the hybrid drive data with the vehicle location data; and,
a memory configured to record the correlated hybrid drive data and vehicle location data.

30. The hybrid vehicle data logging device of claim 29, wherein the first receiver is further configured to receive hybrid drive data communicated over a Controller Area Network (CAN) bus.

31. The hybrid vehicle data logging device of claim 29, wherein the memory includes a vehicle data storage device onboard the vehicle.

32. The hybrid vehicle data logging device of claim 29, wherein the memory includes a data storage device located remotely from the vehicle, the hybrid vehicle data logging device further comprising a transmitter configured to transmit hybrid drive data and vehicle location data to the data storage device located remotely from the vehicle.
